(19) United States
(12) Patent Application Publication
(10) Pub. No.: US 2024/0177612 A1
(43) Pub. Date: May 30, 2024

(54) INFORMATION PROCESSING APPARATUS, INFORMATION PROCESSING METHOD, AND NON-TRANSITORY COMPUTER-READABLE STORAGE MEDIUM

(71) Applicant: NEC Corporation, Tokyo (JP)

(72) Inventors: Bantaro WATARI, Tokyo (JP); Takenori Sato, Tokyo (JP); Michihiko Yusa, Tokyo (JP)

(73) Assignee: NEC Corporation, Tokyo (JP)

(21) Appl. No.: 18/519,304

(22) Filed: Nov. 27, 2023

(30) Foreign Application Priority Data
Nov. 30, 2022 (JP) 2022-191237

(51) Int. Cl. G08G 1/00; G01W 1/02; G01W 1/10; G06V 20/52; G06V 40/10; G08G 1/01; G08G 1/123

(52) U.S. Cl. CPC G08G 1/202; G01W 1/02; G01W 1/10; G06V 20/52; G06V 40/10; G08G 1/0129; G08G 1/0133; G08G 1/123

(57) ABSTRACT

An information processing apparatus includes an image acquisition unit that acquires an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively, and a generation unit that by processing the image, generates car allocation information of a taxi for the plurality of passenger waiting regions.

This application is based upon and claims the benefit of priority from Japanese Patent Application No. 2022-191237 filed on Nov. 30, 2022, the disclosure of which is incorporated herein in its entirety by reference.

### TECHNICAL FIELD

The present invention relates to a car allocation system, an information processing apparatus, an information processing method, and a program.

### BACKGROUND ART

Patent Document 1 (Japanese Patent Application Publication No. 2020-194366) describes one example of a car allocation system for a taxi or the like. Patent Document 2 (Japanese Patent Application Publication No. 2004-347863) describes a taxi waiting display system that can display, within a train, a waiting state of a taxi at each station.

Patent Documents 1 and 2 describe that congestion status of taxi waiting is determined from a captured image.

Patent Document 3 (Japanese Patent Application Publication No. 2022-19268) describes that a time-series change of congestion status is predicted by use of weather. Patent Document 4 (Japanese Patent Application Publication No. 2013-130906) describes that distribution status of a taxi user is predicted by utilizing weather information, and a distribution diagram is displayed.

### SUMMARY OF INVENTION

In techniques described in Patent Documents 1 to 4 above, car allocation is performed according to congestion status in a specific place. Thus, with the techniques described in Patent Documents 1 to 4, car allocation to a plurality of taxi stands cannot be performed according to congestion status at each of taxi stands in a plurality of different places. Accordingly, the present inventor has considered optimizing car allocation to a plurality of taxi stands according to congestion status at each of taxi stands in a plurality of different places.

In view of the problem described above, one example of an object of the present invention is to provide a car allocation system, an information processing apparatus, an information processing method, and a program that solve a problem that car allocation to taxi stands in a plurality of different places cannot be performed.

According to one aspect of the present invention, there is provided an information processing apparatus including:
at least one memory configured to store instructions; and
at least one processor configured to execute the instructions to:
acquire an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
by processing the image, generate car allocation information of a taxi for the plurality of passenger waiting regions.

According to one aspect of the present invention, there is provided an information processing method including,
by one or more computers:
acquiring an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
by processing the image, generating car allocation information of a taxi for the plurality of passenger waiting regions.

According to one aspect of the present invention, there is provided a program that causes a computer to execute:
an image acquisition processing of acquiring an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
a generation processing of generating, by processing the image, car allocation information of a taxi for the plurality of passenger waiting regions.

According to one aspect of the present invention, there is provided a car allocation system including:
a server; and
a plurality of sensor apparatuses provided for each of a plurality of passenger waiting regions where a person waiting for a taxi exists, wherein
each of the plurality of sensor apparatuses includes an image capturing unit having an image capturing range including the plurality of passenger waiting regions, and
the servers includes:
at least one memory configured to store instructions; and
at least one processor configured to execute the instructions to:
acquire an image from each of the plurality of image capturing units, and
by processing the image, generate car allocation information of a taxi for the plurality of passenger waiting regions.

Note that, another aspect of the present invention may be a program causing at least one or more computers to execute the method according to the one aspect described above, or may be a computer-readable storage medium storing such a program. The storage medium includes a non-transitory tangible medium.

The computer program includes a computer program code causing, when executed by a computer, the computer to implement the information processing method on an information processing apparatus.

Note that, any combination of the above components, and a conversion of an expression of the present invention among a method, an apparatus, a system, a storage medium, a computer program, and the like are also effective as an aspect of the present invention.

Moreover, various components according to the present invention do not necessarily need to be independent of each other, and may be in such a way that a plurality of components are formed as one member, one component is formed of a plurality of members, a certain component is a part of another component, a part of a certain component overlaps with a part of another component, or the like.

Moreover, although the method and the computer program according to the present invention describe a plurality of pieces of processing in order, the order of description does not limit an order in which the plurality of pieces of processing are executed. Thus, when implementing the method and the computer program according to the present invention, the order of the plurality of pieces of processing can be changed within a scope that does not cause inconvenience in terms of content.

Furthermore, the method and the plurality of pieces of processing of the computer program according to the present invention are not limited to being executed at timing different from each other. Thus, there may be such a case that, during execution of a certain piece of processing, another piece of processing is executed, may be such a case that execution timing of a certain piece of processing and execution timing of another piece of processing partly or entirely overlap with each other, or the like.

According to one aspect of the present invention, a car allocation system, an information processing apparatus, an information processing method, and a program that can optimize car allocation to taxi stands in a plurality of different places can be acquired.

### BRIEF DESCRIPTION OF THE DRAWINGS

FIG. 1 is a diagram illustrating an outline of an information processing apparatus according to an example embodiment.

FIG. 2 is a flowchart illustrating an operation example of the information processing apparatus according to the example embodiment.

FIG. 3 is a diagram conceptually illustrating a system configuration of a car allocation system according to the example embodiment.

FIG. 4 is a block diagram illustrating a hardware configuration of a computer that achieves the information processing apparatus in FIG. 1.

FIG. 5 is a diagram illustrating a data structure example of getting on/off place information.

FIG. 6 is a diagram illustrating a data structure example of sensor information.

FIG. 7 is a diagram illustrating a data structure example of sensor acquisition information.

FIG. 8 is a diagram illustrating a data structure example of queue person count information.

FIG. 9 is a diagram illustrating a data structure example of car allocation information.

FIG. 10 is a flowchart illustrating an operation example of a server according to the example embodiment.

FIG. 11 is a diagram conceptually illustrating a system configuration of a car allocation system according to an example embodiment.

FIG. 12 is a diagram illustrating one example of a sensor apparatus.

FIG. 13 is a functional block diagram illustrating a functional configuration example of an information processing apparatus according to the example embodiment.

FIG. 14 is a diagram illustrating a data structure example of sensor transmission data.

FIG. 15 is a flowchart illustrating an operation example of a server according to an example embodiment.

FIG. 16 is a diagram conceptually illustrating a system configuration of a car allocation system according to the example embodiment.

FIG. 17 is a functional block diagram illustrating a functional configuration example of an information processing apparatus according to the example embodiment.

FIG. 18 is a diagram illustrating a data structure example of achievement information.

FIG. 19 is a flowchart illustrating an operation example of a server according to the example embodiment.

FIG. 20 is a functional block diagram illustrating a logical configuration example of an information processing apparatus according to an example embodiment.

FIG. 21 is a diagram illustrating a data structure example of contents information.

FIG. 22 is a functional block diagram logically illustrating a configuration example of an on-vehicle apparatus.

FIG. 23 is a flowchart illustrating an operation example of a server according to the example embodiment.

FIG. 24 is a diagram conceptually illustrating a system configuration of a car allocation system according to an example embodiment.

FIG. 25 is a flowchart illustrating an operation example of a server according to the example embodiment.

FIG. 26 is a functional block diagram illustrating a logical configuration example of an information processing apparatus according to an example embodiment.

FIG. 27 is a flowchart illustrating an operation example of a server according to the example embodiment.

FIG. 28 is a diagram conceptually illustrating a system configuration of a car allocation system according to an example embodiment.

FIG. 29 is a flowchart illustrating an operation example of a server according to the example embodiment.

FIG. 30 is a functional block diagram illustrating a logical configuration example of an information processing apparatus according to another example embodiment 1.

### EXAMPLE EMBODIMENT

Hereinafter, example embodiments of the present invention are described by use of the drawings. Note that, in all of the drawings, a similar component is assigned with a similar reference sign, and description thereof is not included as appropriate. Moreover, in each of the following figures, a configuration of a part that is not concerned with essence of the present invention is not included, and is not illustrated.

In the example embodiment, “acquisition” includes at least one of fetching, by a local apparatus, data or information stored in another apparatus or a storage medium (active acquisition), and inputting, into a local apparatus, data or information output from another apparatus (passive acquisition). Examples of active acquisition include requesting or inquiring of the another apparatus and receiving a reply thereof, accessing the another apparatus or the storage medium and reading, and the like. Moreover, an example of passive acquisition includes receiving information given by distribution (or transmission, push notification, or the like), and the like. Further, “acquisition” may include selecting and acquiring from received data or information, or selecting and receiving distributed data or information.

### <Confutation Example>

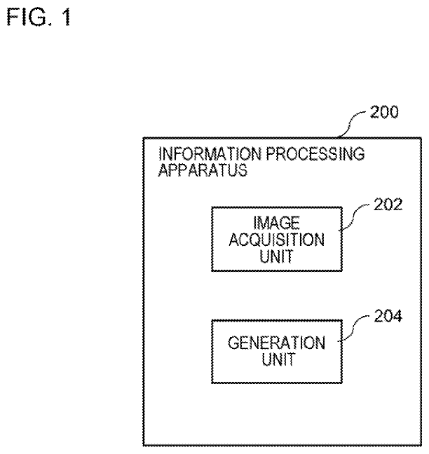

FIG. 1 is a diagram illustrating an outline of an information processing apparatus 200 according to an example embodiment. The information processing apparatus 200 includes an image acquisition unit 202 and a generation unit 204.

The image acquisition unit 202 acquires an image from each of a plurality of image capturing units being provided for each of a plurality of passenger waiting regions where a person waiting for a taxi exists. The plurality of image capturing units each have an image capturing range. The image capturing ranges of the plurality of image capturing units include the plurality of passenger waiting regions in an image capturing range, respectively. The generation unit 204, by processing the image, generates car allocation information of a taxi for the plurality of passenger waiting regions.

### Operation Example

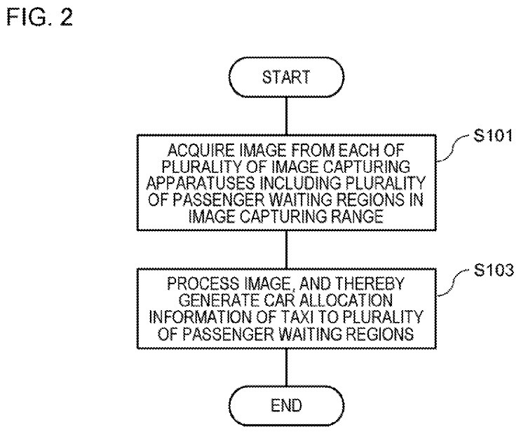

FIG. 2 is a flowchart illustrating an operation example of the information processing apparatus 200 according to the example embodiment.

The image acquisition unit 202 acquires an image from each of a plurality of image capturing units being provided for each of a plurality of passenger waiting regions where a person waiting for a taxi exists, and including the plurality of passenger waiting regions in an image capturing range (step S101).

The generation unit 204, by processing the image, generates car allocation information of a taxi for the plurality of passenger waiting regions (step S103).

The information processing apparatus 200 includes the image acquisition unit 202 and the generation unit 204. The image acquisition unit 202 acquires an image from each of a plurality of image capturing units including the plurality of passenger waiting regions in an image capturing range. The generation unit 204 by processing the image, generates car allocation information of a taxi for a plurality of passenger waiting regions.

The information processing apparatus 200 can optimize car allocation to taxi stands in a plurality of different places.

A detailed example of the information processing apparatus 200 is described below.

### First Example Embodiment

### <System Outline>

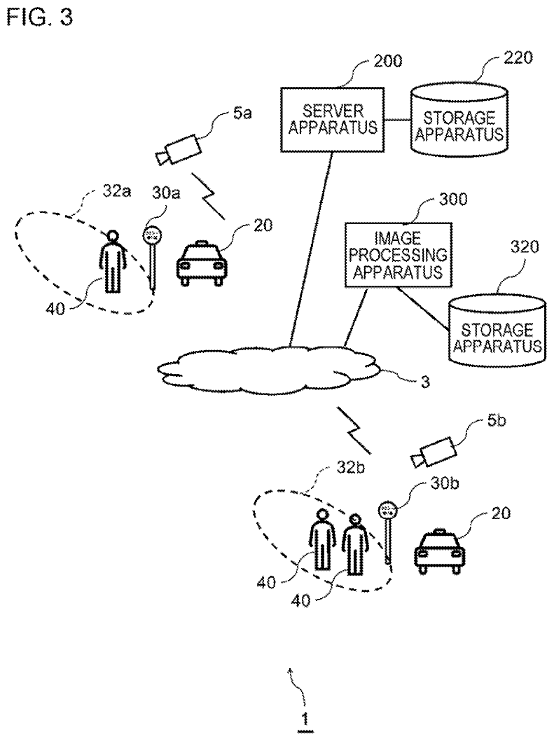

FIG. 3 is a diagram conceptually illustrating a system configuration of a car allocation system 1 according to the example embodiment. The car allocation system 1 performs car allocation of a taxi 20 at taxi on/off places 30 in a plurality of locations. However, the car allocation system 1 is applicable not only to car allocation of a taxi but also to car allocation of a movement unit by autonomous driving to a plurality of taxi getting on/off places of the movement unit.

The car allocation system 1 includes a server 200. The server 200 is one example of the information processing apparatus 200 in FIG. 1, and is described by being assigned with the same reference sign. A camera 5 is installed at each of the taxi on/off places 30 in a plurality of locations. The taxi on/off place 30 is provided, for example, in or around a premise in front of or around a station, or in or around a premise of an establishment such as a large-scale commercial establishment, a hotel, a factory, a hospital, or a university. The camera 5 is one example of an image capturing unit. In the example of FIG. 3, a first camera 5a and a second camera 5b are installed at a first taxi getting on/off place 30a and a second taxi getting on/off place 30b, respectively. Then, the first camera 5a and the second camera 5b each have an image capturing range. The image capturing ranges the first camera 5a and the second camera 5b of include a first passenger waiting region 32a and a second passenger waiting region 32b, respectively. A person 40 waiting for a taxi exists in each of the first passenger waiting region 32a and the second passenger waiting region 32b.

Hereinafter, when it is not particularly necessary to distinguish, the first taxi getting on/off place 30a and the second taxi getting on/off place 30b are simply referred to as the taxi on/off place 30, the first camera 5a and the second camera 5b are simply referred to as the camera 5, and the first passenger waiting region 32a and the second passenger waiting region 32b are simply referred to as a passenger waiting region 32. The server 200 is connected to the plurality of cameras 5 via a communication network 3. However, the communication network 3 may be a combination of a plurality of different networks (e.g., a mobile communication network and a local area network (LAN) or the like).

The server 200 includes a storage apparatus 220. The storage apparatus 220 may be provided inside the server 200, or may be provided outside the server 200. That is to say, the storage apparatus 220 may be hardware being integral with the server 200, or may be hardware being separate from the server 200.

The server 200 is connected to an image processing apparatus 300 via the communication network 3. The image processing apparatus 300 processes an image generated by the camera 5. The image processing apparatus 300 includes a storage apparatus 320. The storage apparatus 320 may be provided inside the image processing apparatus 300, or may be provided outside the image processing apparatus 300. That is to say, the storage apparatus 320 may be hardware being integral with the image processing apparatus 300, or may be hardware being separate from the image processing apparatus 300.

The storage apparatus 320 may be composed of a plurality of storage apparatuses. For example, a certain storage apparatus 320 may store an image generated by the camera 5. Moreover, another storage apparatus 320 may have a function as a storage unit that stores learning model used when the image processing apparatus 300 performs information processing.

The image processing apparatus 300 may be provided inside the server 200, or may be provided outside the server 200. That is to say, the image processing apparatus 300 may be hardware being integral with the server 200, or may be hardware being separate from the server 200. Moreover, although the server 200 and the image processing apparatus 300 are connected to each other by the communication network 3 in the figure, connection between the server 200 and the image processing apparatus 300 is not limited to network connection.

The camera 5 includes a lens and an image capturing element such as a charge coupled device (CCD), and is, for example, a network camera such as an Internet protocol (IP) camera. The network camera has, for example, a wireless local area network (LAN) communication function, and is connected to the server 200 or the image processing apparatus 300 via the communication network 3, i.e., a relay apparatus (not illustrated) such as a router. The cameras 5 may be so-called security cameras installed in a street. Then, the camera 5 may include a mechanism that performs control of orientation of a camera body or a lens, zoom control, focusing, or the like.

An image generated by the camera 5 is preferably captured in real time, and transmitted to the server 200 or the image processing apparatus 300. However, an image transmitted from the camera 5 may not be directly transmitted from the camera 5, and may be an image delayed a predetermined time (e.g., several seconds to several minutes). An image captured by the camera 5 may be temporarily stored in another storage apparatus (not illustrated), and read from the storage apparatus by the server 200 or the image processing apparatus 300 sequentially or at each predetermined time interval (e.g., several seconds to several minutes). Further, an image transmitted from the camera 5 is preferably a moving image, but may be a frame image at each predetermined interval, or may be a still image.

An image generated by the camera 5 is, for example, transmitted to the server 200, and stored in the storage apparatus 220. The server 200 transmits an image to the image processing apparatus 300. The image processing apparatus 300 stores the received image in the storage apparatus 320, processes the image, and transmits a result thereof to the server 200. In another example, an image generated by the camera 5 may be transmitted to the image processing apparatus 300, and stored in the storage apparatus 320. The image processing apparatus 300 may process a received image, and transmit a result thereof to the server 200.

As described above, the camera 5 includes the passenger waiting region 32 in an image capturing range. When a large number of the persons 40 queue at the taxi on/off place 30, the camera 5 may split the passenger waiting region 32 into a plurality of regions, and generate a plurality of images with each of the split regions as an image capturing range.

### <Hardware Confutation Example>

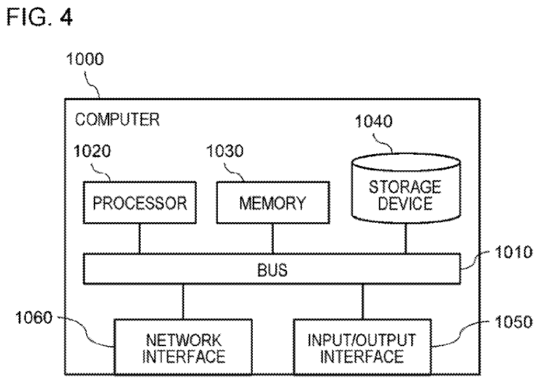

FIG. 4 is a block diagram illustrating a hardware configuration of a computer 1000 that achieves the information processing apparatus 200 in FIG. 1. The information processing apparatus 200 in FIG. 3 is achieved by the computer 1000. A function of the information processing apparatus 200 may be achieved, in a shared way, by the server 200 and another server (e.g., a server of a taxi company described in an example embodiment described later, a contents distribution server or the like, or an on-vehicle apparatus or the like mounted on the taxi 20). A server of a taxi company described in an example embodiment described later, a contents distribution server, a control unit 52 of the on-vehicle apparatus mounted on the taxi 20, or the like is also achieved by the computer 1000. Further, a control unit 116 of a sensor apparatus 100 described in the example embodiment described later is also achieved by the computer 1000.

The computer 1000 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from each another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module including a processing procedure that achieves each function (e.g., the image acquisition unit 202, the generation unit 204, and a weather information acquisition unit 206, an achievement information acquisition unit 208, a person determination unit 210, an output processing unit 212, a detection unit 214, and the like described later) of the information processing apparatus 200. The processor 1020 reads each of the program modules onto the memory 1030, executes each piece of processing included in the program module according to the procedure, and thereby achieves each function being associated with the program module. Moreover, the storage device 1040 may also function as the storage apparatus 220 of the server 200 and the storage apparatus 320 of the image processing apparatus 300. Further, the storage device 1040 may also function as a storage apparatus 420 of an external server apparatus 400 described later, or a storage unit 54 of an on-vehicle apparatus 50.

The program module may be stored in a storage medium. A storage medium storing the program module may include a non-transitory tangible medium usable by the computer 1000, and a program code readable by the computer 1000 (the processor 1020) may be embedded in the medium.

The input/output interface 1050 is an interface for connecting the computer 1000 to various kinds of input/output equipment. The input/output interface 1050 also functions as a communication interface that performs near-field wireless communication such as Bluetooth (registered trademark) and near field communication (NFC).

The network interface 1060 is an interface for connecting the computer 1000 to the communication network 3. The communication network 3 is, for example, at least one of mobile communication network, a local area network (LAN), a wide area network (WAN), and the like. A method of connecting the network interface 1060 to the communication 3 network may be wireless connection, or may be wired connection.

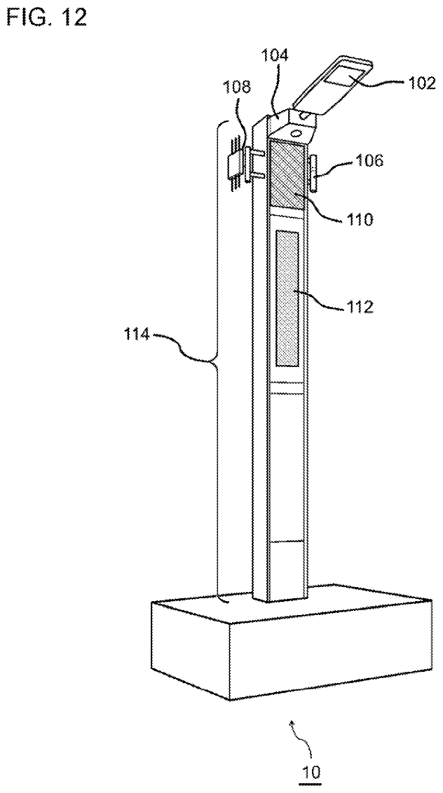

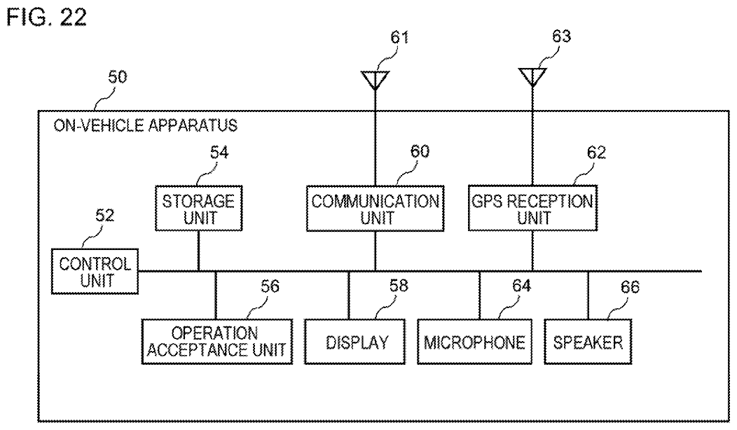

Then, the computer 1000 is connected, via the input/output interface 1050 or the network interface 1060, to necessary equipment (e.g., a keyboard, a mouse, a speaker, a microphone, a printer, or the like of the non-illustrated server 200, a light source 102, an image capturing unit 104, a sensor group 106, a communication unit 108, a speaker 110, a display 112, or the like of the sensor apparatus 100 in FIG. 12, or an operation acceptance unit 56, a display 58, a communication unit 60, a GPS reception unit 62, a microphone 64, a speaker 66 or the like of the on-vehicle apparatus 50 in FIG. 22).

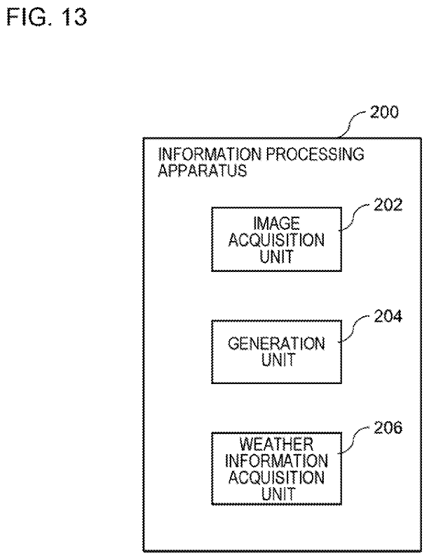

Each component of the information processing apparatus 200 (server 200) in each of the example embodiments in FIG. 1 and FIGS. 13, 17, 20, 26, and 30 described later is achieved by any combination of hardware and software of the computer 1000 in FIG. 4. Then, it is appreciated by a person skilled in the art that there are a variety of modified examples of a method and an apparatus for the achievement. A functional block diagram illustrating the information processing apparatus 200 according to each of the example embodiments illustrates not a configuration on a hardware basis but a block on a logical function basis.

### Functional Configuration Example

A functional configuration example of the information processing apparatus 200 according to the example embodiment is described below by use of FIG. 1. As described above, the server 200 is one example of the information processing apparatus 200 in FIG. 1.

The server 200 includes the image acquisition unit 202 and the generation unit 204.

The image acquisition unit 202 acquires an image from each of the plurality of cameras 5 (one example of an image capturing unit). Each of the plurality of cameras 5 has an image capturing range. The image capturing ranges of the plurality of the cameras 5 include the plurality of passenger waiting regions 32, respectively. The image acquisition unit 202 stores the acquired image in the storage apparatus 220 as sensor acquisition information 330. As another example, the image acquisition unit 202 may not store the acquired image in the storage apparatus 220, and may transfer the acquired image to the image processing apparatus 300. Alternatively, an image may be directly transferred from the camera 5 to the image processing apparatus 300. In a case of the another example, the image processing apparatus 300 stores a received image in the storage apparatus 320.

Each of the cameras 5 has an image capturing range including the passenger waiting region 32 of a taxi getting on/off place 30. For example, identification information (hereinafter, also referred to as a getting on/off place ID) determining the passenger waiting region 32 of each getting on/off place is allocated to the plurality of taxi getting on/off places 30. Moreover, identification information (hereinafter, also referred to as a sensor ID) determining each of the cameras 5 is allocated to the plurality of cameras 5.

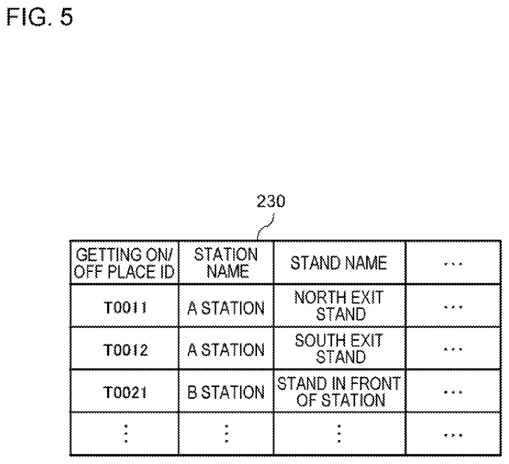

FIG. 5 is a diagram illustrating a data structure example of getting on/off place information 230. The getting on/off place information 230 includes at least a getting on/off place ID and information indicating a place of the passenger waiting region 32 in association with each other for each of the passenger waiting regions 32 of the taxi getting on/off place 30. The information indicating a place of the passenger waiting region 32 includes a station name and a stand name, as one example. However, the information indicating a place of the passenger waiting region 32 is not limited thereto. As another example, the information indicating a place of the passenger waiting region 32 may include an establishment name (e.g., a factory B of a company A, a university C, or the like), and a stand name (e.g., a stand in front of a front gate, a north gate stand, or the like). As still another example, the information indicating a place of the passenger waiting region 32 may include position information such as an address or latitude and longitude information.

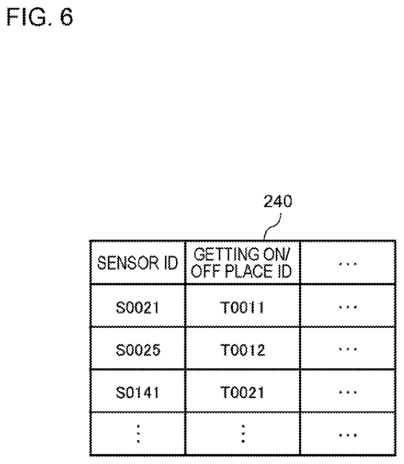

FIG. 6 is a diagram illustrating a data structure example of sensor information 240. The sensor information 240 includes, for each of the cameras 5, at least a sensor ID, and a getting on/off place ID determining the taxi getting on/off place 30 (the passenger waiting region 32) that the camera 5 captures, in association with each other.

The camera 5 may store information determining the camera 5. In this case, the camera 5 transmits, to the information processing apparatus 200, a sensor ID in association with a generation date and time of an image, and image data. Alternatively, an IP address of a network camera may be utilized for the sensor ID. In this case, the camera 5 may not transmit the sensor ID in association with image data. The image acquisition unit 202 determines, as a sensor ID, an IP address specified when connecting to the camera 5 in order to acquire an image, and stores the IP address in the storage apparatus 220 as the sensor acquisition information 330, in association with acquired image data.

The camera 5 is one example of a sensor that detects a state of the passenger waiting region 32. The server 200 according to the example embodiment described later further uses another sensor that detects a state of the passenger waiting region 32. Thus, a sensor ID may further include information indicating a type of a sensor. For example, a sensor ID of the camera 5 may include, at a head, a predetermined English latter (“S” in the example of FIG. 6) indicating that a sensor type is a camera, and include, thereafter, a number of a predetermined digit number.

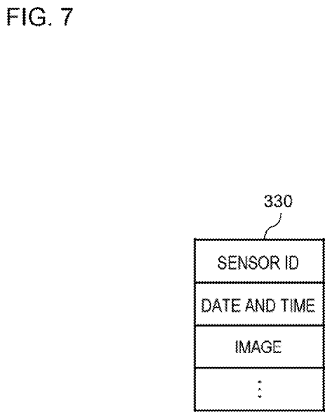

FIG. 7 is a diagram illustrating a data structure example of the sensor acquisition information 330.

The sensor acquisition information 330 includes, for each of the cameras 5, a sensor ID being information determining the camera 5, a date and time of an acquired image, and image data, in association with each other.

A date and time of an image is, for example, a date and time of receiving image data from the camera 5, a date and time of saving image data in the storage apparatus 220 (or the storage apparatus 320), or the like. A substantive file itself of image data may not be saved in the sensor acquisition information 330. For example, the sensor acquisition information 330 may include information (or a path indicating a storage place and a file name) indicating a storage place (at least one of a disc name, a folder name, a directory name, and the like) of image data, and a file name. An image data file may be stored in a predetermined storage area of the storage apparatus 220.

As one example, the image acquisition unit 202 acquires, from each of the cameras 5, video data for a predetermined time interval (for 10 minutes) at every predetermined time interval (e.g., every 10 minutes), and stores the video data in the storage apparatus 220 as the sensor acquisition information 330. As another example, the image acquisition unit 202 acquires, from each of the cameras 5 at each predetermined time interval (e.g., every 10 minutes), image data (a still image or images of a plurality of frames) at the time, and stores the image data in the storage apparatus 220 as the sensor acquisition information 330.

The generation unit 204, by processing the image, generates car allocation information of the taxi 20 for the plurality of passenger waiting regions 32. Specifically, first, the generation unit 204 causes the image processing apparatus 300 to process the image, and thereby determines a person count in a taxi queue in each of the passenger waiting regions 32.

The image processing apparatus 300 processes the image, thereby determines the passenger waiting region 32 within the image, and determines a region where the person 40 exists within the passenger waiting region 32. Then, the image processing apparatus 300 counts at least a part (e.g., a head region or the like) of the person 40, and determines a person count within the passenger waiting region 32. The determined person count is transmitted to the server 200.

The generation unit 204 stores the person count in a taxi queue in each of the taxi getting on/off places 30 acquired from the image processing apparatus 300, in the storage apparatus 220 as queue person count information 250 for each of the taxi getting on/off places 30.

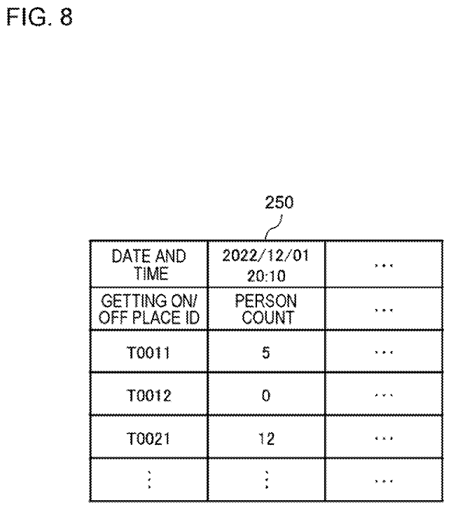

FIG. 8 is a diagram illustrating a data structure example of the queue person count information 250.

The queue person count information 250 stores a person count in a taxi queue in each of the taxi getting on/off places 30 at a certain time.

Note that, a timing of determining a person count is preferably, for example, each time (herein, referred to as a turn-around time of car allocation processing) interval in which the taxi 20 is called based on car allocation information of the taxi 20, and then the taxi 20 arrives at the taxi getting on/off place 30, causes a customer to get on, and arrives at a destination. As one example, a timing of determining a person count is every turn-around time of car allocation processing, and is, for example, every 30 minutes. However, the turn-around time of car allocation processing differs depending on the taxi getting on/off place 30, a day of a week, a time period, or the like. Thus, a timing of determining a person count may also be caused to differ according to at least one of the taxi getting on/off place 30, a day of a week, and a time period.

A person count in a queue may be determined by use of only an image at a certain time, or may be an average value, a maximum value, or the like, between turn-around times of car allocation processing, of a person count at each time determined by use of a plurality of images at a plurality of times between turn-around times of car allocation processing.

The generation unit 204 refers to the queue person count information 250, and generates car allocation information of the taxi 20 by use of person counts in taxi queues in the plurality of taxi getting on/off places 30. As one example, the generation unit 204 allots the number of the allocatable taxies 20 according to a proportion of person counts in taxi queues in the plurality of taxi getting on/off places 30. The generation unit 204 stores generated car allocation information 260 of the taxi 20 in the storage apparatus 220.

The allocatable taxi 20 is, for example, the taxi 20 running empty which no customer is caused to get on, or the taxi 20 being on standby, and is the taxi 20 being present within a car allocation area, or at a position where a travel distance to a car allocation destination or a time taken to arrive at a car allocation destination is within a predetermined range.

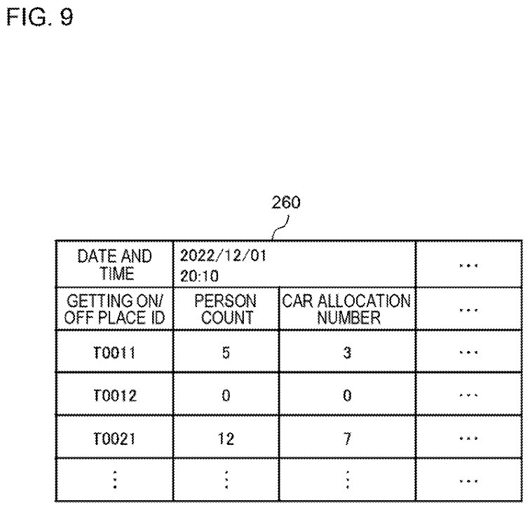

FIG. 9 is a diagram illustrating a data structure example of the car allocation information 260.

The car allocation information 260 includes a person count in a taxi queue in each of the taxi getting on/off places 30 at a certain time, and the number of the allotted taxies 20, in association with each other.

In the example of FIG. 9, person counts in taxi queues in the passenger waiting regions 32 of the three taxi getting on/off places 30 are 5, 0, and 12. The generation unit 204 allots, to each of the passenger waiting regions 32, the number of the allocatable taxies 20 in the proportion of person counts in the taxi queue. In this example, the generation unit 204 allots the ten taxies 20 in such a way as 3:0:7 in a proportion of 5:0:12.

### Operation Example

An operation example of the server 200 according to the example embodiment is described below.

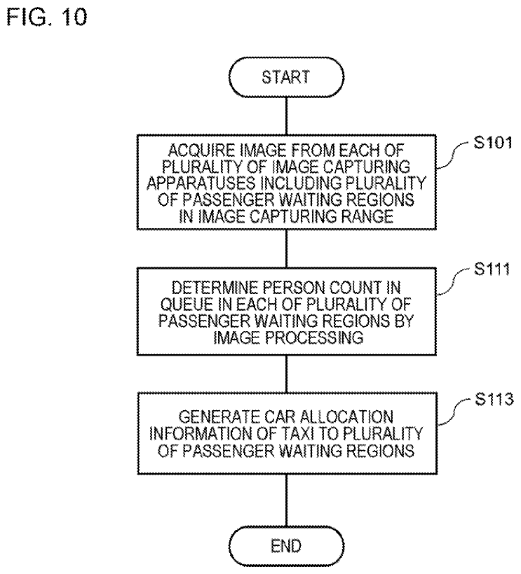

FIG. 10 is a flowchart illustrating the operation example of the server 200 according to the example embodiment. A flow in FIG. 10 has step S101 that is the same as that in a flow in FIG. 2, and further has steps S111 and S113 in place of S103.

Step S101 is executed regularly, at a predetermined time, or at any time. Steps S101, S111, and S113 may be executed asynchronously with each other. For example, steps S111 and S113 are executed at a turn-around time interval of car allocation processing.

First, the image acquisition unit 202 acquires an image from each of the plurality of cameras 5 installed at the plurality of taxi on/off places 30 (step S101). The image acquisition unit 202 stores the acquired image in the storage apparatus 220 as the sensor acquisition information 330.

The generation unit 204 causes the image processing apparatus 300 to process an image, and thereby determines a person count in a taxi queue in each of the passenger waiting regions 32 (step S111). The generation unit 204 stores the person count in a taxi queue in the storage apparatus 220 as the queue person count information 250 for each of the passenger waiting regions 32.

Then, the generation unit 204 refers to the queue person count information 250, and generates the car allocation information 260 of the taxi 20 by use of person counts in taxi queues in the plurality of taxi getting on/off places 30 (step S113). The generation unit 204 stores the generated car allocation information 260 in the storage apparatus 220.

The car allocation information 260 can be displayed on, for example, a display of a terminal of a non-illustrated taxi company. In the taxi company, an operator can perform car allocation by calling the allocatable taxi 20, based on the car allocation information 260, and informing the taxi 20 of the taxi getting on/off place 30 of a destination. Alternatively, an automatic car allocation system (not illustrated) of the taxi company may automatically call the allocatable taxi 20 by use of the car allocation information 260.

As described above, the information processing apparatus 200 includes the image acquisition unit 202 and the generation unit 204. The image acquisition unit 202 acquires an image from each of a plurality of image capturing units including a plurality of passenger waiting regions in an image capturing range. The generation unit 204, by processing the image, generates car allocation information of a taxi for the plurality of passenger waiting regions.

According to the present example embodiment, the car allocation system 1, the information processing apparatus 200, an information processing method, and a program that can optimize car allocation to taxi stands in a plurality of different places can be obtained.

### Second Example Embodiment

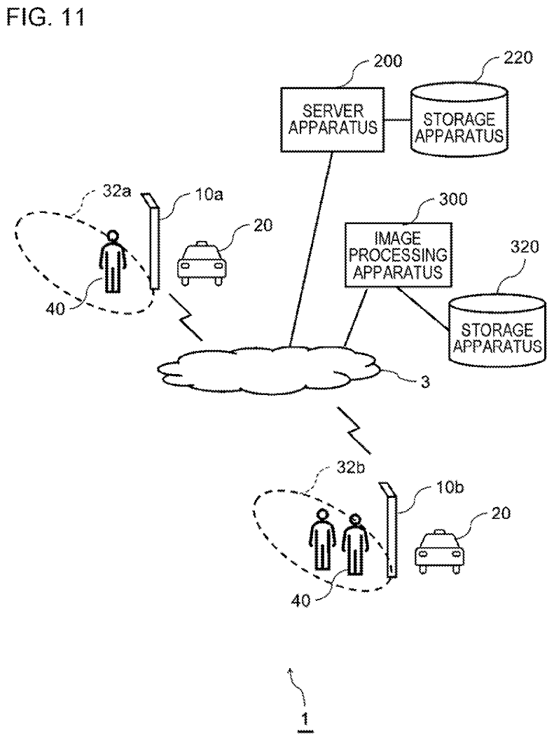

FIG. 11 is a diagram conceptually illustrating a system configuration of a car allocation system 1 according to an example embodiment. The present example embodiment is different from the example embodiment described above in including a configuration that acquires an image generated by use of an image capturing unit (an image capturing unit 104 described later) installed in a street light 10 in place of a camera 5 in FIG. 3. Moreover, as described later, the present example embodiment is different from the example embodiment described above in including a configuration that performs car allocation of a taxi further by use of weather information. However, a configuration according to the present example embodiment may be combined with at least one of configurations according to other example embodiments described later to an extent that produces no conflict.

### <System Outline>

The car allocation system 1 according to the example embodiment is described below by use of FIG. 11.

The plurality of street lights 10 are arranged on a road or in a premise. However, the street lights 10 are arranged in various places. The plurality of street lights 10 are each provided with a sensor apparatus 100. In the present example embodiment, a server 200 performs processing by use of data acquired from the sensor apparatus 100 of the street light 10 installed in places of taxi getting on/off places 30 in a plurality of locations from among the street lights 10.

The sensor apparatus 100 of at least one street light 10a is installed in a place of a first taxi getting on/off place 30a, and the sensor apparatus 100 of at least one street light 10b is installed in a place of a second taxi getting on/off place 30b. The server 200 stores data generated by the sensor apparatus 100, in a storage apparatus 220 as sensor acquisition information 330 described later, in association with the taxi getting on/off place 30 being associated with an installation place of the sensor apparatus 100.

FIG. 12 is a diagram illustrating one example of the sensor apparatus 100. In the example illustrated in the present figure, the sensor apparatus 100 also serves as the street light 10. The sensor apparatus 100 includes a light source 102 such as an LED, an image capturing unit 104, a sensor group 106, a communication unit 108, a speaker 110, and a display 112. The sensor apparatus 100 further includes a control unit 116 that controls the light source 102, the image capturing unit 104, the sensor group 106, the communication unit 108, the speaker 110, and the display 112 of the sensor apparatus 100.

Each of the image capturing unit 104 and the sensor group 106 is one example of a sensor provided in the sensor apparatus 100, and is supported by the same support member. A support column 114 is one example of a support member, and the image capturing unit 104 and the sensor group 106 are installed on a top of the support column 114. Moreover, the sensor group 106 includes, for example, an illumination sensor, a temperature sensor, a humidity sensor, a vibration sensor, an inclination sensor, and the like.

The image capturing unit 104 has an image capturing range including a region looking down from the top of the support column 114, i.e., a road or a premise where the sensor apparatus 100 is installed. Thus, the support column 114 can capture an image of a moving body existing on a road or a premise where the sensor apparatus 100 is installed, such as a person, a bicycle, and a vehicle. In the example illustrated in the present figure, the image capturing unit 104 is located near the light source 102, for example, in a part in which the light source 102 is attached to the support column 114. In this way, when a light amount of natural light is insufficient at night or the like, the light source 102 can also serve as the image capturing unit 104.

In the present example embodiment, an image capturing range of the image capturing unit 104 is set in such a way as to include a passenger waiting region 32 where a person 40 waiting for a taxi 20 in the taxi getting on/off place 30 exists. The image capturing unit 104 is another example of an image capturing unit that replaces the camera 5 in FIG. 3.

In the present example embodiment, the sensor group 106 includes at least a sensor that acquires data relating to weather information. For example, the sensor group 106 includes a sensor that measures at least one of temperature, humidity, air pressure, a wind speed, a wind amount, an amount of water vapor, and an amount of precipitation. Data measured by various sensors are hereinafter referred to as weather data.

An image generated by the image capturing unit 104 and various pieces of data (image data and weather data) generated by the sensor group 106 are transmitted to the server 200 by the communication unit 108 together with information (hereinafter, referred to as sensor identification information) with which the sensor apparatus 100 is identifiable. Data transmitted from the sensor apparatus 100 to the server 200 are hereinafter referred to as sensor transmission data 340.

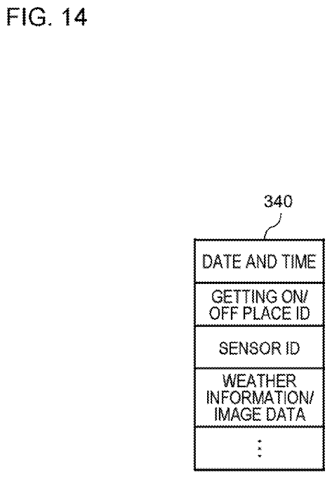

FIG. 14 is a diagram illustrating a data structure example of the sensor transmission data 340.

The sensor transmission data 340 include an image generated by the image capturing unit 104 and various pieces of data generated by the sensor group 106. Specifically, the sensor transmission data 340 include, in association with a generation date and time of data, information (hereinafter, referred to as sensor type information) indicating a type of a sensor that has generated the data, and data (image data or various pieces of weather data) generated by each sensor. Note that, the sensor type information may be included in sensor identification information. For example, a sensor ID of the image capturing unit 104 may include, at a head, a predetermined English latter (“S” in the example of FIG. 6) indicating that a sensor type is a camera, and include, thereafter, a number of a predetermined digit number.

As described with FIG. 6, a sensor ID with which the image capturing unit 104 and a sensor of the sensor group 106 are identifiable is associated, as sensor information 240, with a getting on/off place ID of the taxi getting on/off place 30 where the sensor apparatus 100 is installed. Thus, in another example, the sensor transmission data 340 may not necessarily include a getting on/off place ID.

A getting on/off place ID may be identification information allocated specifically to each of the sensor apparatuses 100 installed in the taxi getting on/off place 30. The identification information (or the taxi getting on/off place ID) is stored in, for example, the communication unit 108.

The information with which the sensor apparatus 100 is identifiable may include information (e.g., a station name and a taxi stand name of the taxi getting on/off place 30) indicating a place where the sensor apparatus 100 is installed.

The communication unit 108 is, for example, a wireless communication apparatus, but may be a wired communication apparatus.

The server 200 stores, in the storage apparatus 220, the sensor transmission data 340 received from the sensor apparatus 100. Alternatively, the server 200 may store the sensor transmission data 340 in the sensor acquisition information 330 in FIG. 7 according to the example embodiment described above. In FIG. 7, the sensor acquisition information 330 includes, for each of the cameras 5, a sensor ID being information determining the camera 5, a date and time of an acquired image, and image data, in association with each other. In the present example embodiment, the sensor acquisition information 330 may store, for each sensor, information (herein, a sensor ID) indicating a type of a sensor, a date and time of the sensor transmission data 340, and acquired weather data or image data, in a categorized way.

Herein, the sensor apparatus 100 may transmit an image and/or data to the information processing apparatus 200 after performing predetermined processing (e.g., compression processing of data).

Note that, the sensor apparatus 100 may not serve as a street light 10. In this case, the sensor apparatus 100 includes at least the image capturing unit 104, the sensor group 106, and the communication unit 108, and is preferably attachable to a support column of the already installed street light 10. Alternatively, when sensors of the image capturing unit 104 and the sensor group 106 each have a communication function (e.g., Internet of things (IOT) equipment), the sensor apparatus 100 may include at least the image capturing unit 104 and the sensor group 106.

### Functional Configuration Example

FIG. 13 is a functional block diagram illustrating a functional configuration example of the information processing apparatus 200 according to the example embodiment. The server 200 in FIG. 11 is one example of the information processing apparatus 200.

The information processing apparatus (server) 200 further includes a weather information acquisition unit 206 in addition to a configuration of the information processing apparatus 200 in FIG. 1. However, a configuration according to the present example embodiment may be combined with at least one of configurations according to other example embodiments described later to an extent that produces no conflict.

The weather information acquisition unit 206 acquires weather information of a region including each of the passenger waiting regions 32, regarding the plurality of passenger waiting regions 32.

The generation unit 204 generates car allocation information 260 of a taxi 20, further by use of weather information of each of the passenger waiting regions 32.

The weather information acquisition unit 206 acquires weather information by generating the weather information by use of data generated by a sensor installed in each of the passenger waiting regions 32, regarding the plurality of passenger waiting regions 32.

The sensor installed in each of the passenger waiting regions 32 is a sensor of the sensor group 106 of the sensor apparatus 100 described above. Data generated by the sensor are the sensor transmission data 340, and are received from the sensor apparatus 100 installed in each of the passenger waiting regions 32.

The weather information acquisition unit 206 generates weather information of the current getting on/off place 30 by use of acquired data generated by a sensor. For example, the weather information acquisition unit 206 estimates, by use of data of a rain amount sensor, whether it is raining, or intensity of rain (light rain, heavy rain, torrential rain, or the like). Alternatively, the weather information acquisition unit 206 may compute a discomfort index by use of data of a temperature sensor and a humidity sensor.

The generation unit 204 estimates that users of the taxi 20 are likely to increase, according to a weather condition such as a case where it is raining or a case where intensity of rain is strong (e.g., heavy rain or torrential rain). Thus, the generation unit 204 increases (e.g., multiplies by a coefficient 1.2, or the like) an allocation ratio of car allocation to the taxi getting on/off place 30, according to the weather condition. For example, a coefficient to multiply an allocation ratio is previously set for each weather condition. In a case of a weather condition in which users of the taxi 20 are likely to increase, a coefficient may be set to a value more than 1. Alternatively, in a case of a weather condition in which users of the taxi 20 are likely to decrease, a coefficient may be set to a value less than 1.

A weather condition in which users of the taxi 20 are likely to increase is, for example, raining, intensity of rain being strong (heavy rain, torrential rain, or the like), strong wind in which a wind speed is equal to or more than a threshold value, high temperature and high humidity in which temperature and humidity are equal to or more than a threshold value, low temperature in which temperature is equal to or less than a threshold value, temperature being below a freezing point and an amount of rain being equal to or more than a threshold value (a case where snowfall is estimated), or the like. When at least one condition is satisfied among the conditions, a coefficient may be set to a value more than 1. Alternatively, a coefficient more than 1 may be previously set for each condition, and, when a plurality of conditions are satisfied, the generation unit 204 may multiply and use each coefficient.

A weather condition in which users of the taxi 20 are likely to decrease is, for example, not raining, raining but light rain, weak wind or no wind in which a wind speed is equal to or less than a threshold value, humidity and temperature being equal to or less than a threshold value and no high temperature and high humidity, easy-to-spend temperature in which temperature is within a predetermined range, or the like. When at least one condition is satisfied among the conditions, a coefficient may be set to a value more than 1. Alternatively, a coefficient less than 1 may be previously set for each condition, and, when a plurality of conditions are satisfied, each coefficient may be multiplied and used.

Since a current weather condition is generated and used for generation of the car allocation information 260, increase or the like of an allocation ratio of car allocation of the taxi 20 to the taxi getting on/off place 30 in, for example, an area where a weather condition deteriorates temporarily and locally due to sudden downpour or the like becomes possible.

Moreover, the weather information acquisition unit 206 may acquire prediction information of weather from an external server.

The external server is a web server or the like providing a website for prediction information of weather. The weather information acquisition unit 206 acquires, from the external server, information of weather forecast for an area including a place of the taxi getting on/off place 30. For example, the generation unit 204 may generate the car allocation information 260 further by use of weather forecast for each time on a current day. The generation unit 204 also becomes cable of generating, in advance, the car allocation information 260 for a period (e.g., after 30 minutes) corresponding to, for example, a turn-around time of next car allocation processing by using information of weather forecast.

A configuration that generates the car allocation information 260 of the taxi 20 and a configuration according to the present example embodiment may be combined by use of achievement information of past congestion status for each of the passenger waiting regions 32 according to a third example embodiment described later. For example, achievement information of past congestion status for each of the passenger waiting regions 32 further includes weather information of the passenger waiting region 32 in an associated way. In this way, it becomes possible to acquire an increase and decrease tendency of the number of users of the taxi 20 according to a weather condition according to the present example embodiment. For example, a coefficient of each of the passenger waiting regions 32 may be set for each weather condition, by use of achievement information of past congestion status for each of the passenger waiting regions 32 for each weather information. For example, regarding the passenger waiting region 32 indicating a tendency in which users increase during a rainy weather, a coefficient may be made larger (e.g., larger than 1).

Alternatively, a coefficient may be set according to a proportion of an actual number of users in the plurality of passenger waiting regions 32 for each weather condition acquired from achievement information. Alternatively, as another example embodiment, the generation unit 204 may determine an allocation ratio of the taxi 20 according to a proportion of an actual number of users in the plurality of passenger waiting regions 32 for each weather condition acquired from achievement information, without considering a proportion of a person count in a taxi queue in the passenger waiting regions 32 of the plurality of the taxi getting on/off places 30.

### Operation Example

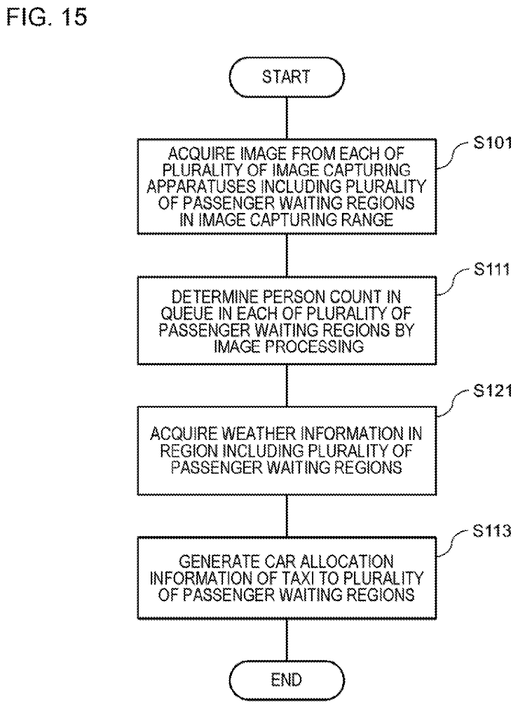

FIG. 15 is a flowchart illustrating an operation example of the server 200 according to the example embodiment. A flow in FIG. 15 includes steps S101, S111, and S113 that are the same as those in a flow in FIG. 10, and further includes step S121.

Steps S101 and S121 are executed regularly, at a predetermined time, or at any time. Moreover, image data acquired in step S101 and weather information acquired in step S121 may be received simultaneously as the sensor transmission data 340. Steps S101, S111, S113, and S121 may be executed asynchronously with each other. For example, steps S111 and S113 are executed at a turn-around time interval of car allocation processing.

First, the image acquisition unit 202 receives image data as the sensor transmission data 340, from the plurality of sensor apparatuses 100 installed in the plurality of taxi getting on/off places 30 (step S101). The image acquisition unit 202 stores the received sensor transmission data 340 in the storage apparatus 220. Further, the image acquisition unit 202 takes out and acquires the image data from the sensor transmission data 340.

The generation unit 204 causes the image processing apparatus 300 to process an image, and thereby determines a person count in a taxi queue in each of the passenger waiting regions 32 (step S111). The generation unit 204 stores the person count in a taxi queue in the storage apparatus 220 as queue person count information 250 for each of the passenger waiting regions 32.

On the other hand, the weather information acquisition unit 206 receives weather data as the sensor transmission data 340, from the plurality of sensor apparatuses 100 installed in the plurality of taxi getting on/off places 30, and acquires weather information (step S121). The weather information acquisition unit 206 stores the received sensor transmission data 340 in the storage apparatus 220. The weather information acquisition unit 206 takes out and acquires the weather data from the sensor transmission data 340 stored in the storage apparatus 220. The weather information acquisition unit 206 may take out and acquire the weather data from the sensor transmission data 340 received by the image acquisition unit 202 in step S101 and stored in the storage apparatus 220.

The weather information acquisition unit 206 generates weather information by use of the acquired weather data.

Then, the generation unit 204 refers to the queue person count information 250, and generates the car allocation information 260 of the taxi 20 by use of person counts in taxi queues in the plurality of taxi getting on/off places 30 and further by use of weather information (step S113). The generation unit 204 determines an allocation ratio of car allocation to each of the taxi getting on/off places 30 by use of person counts in taxi queues in the plurality of taxi getting on/off places 30. Further, the generation unit 204 sets a coefficient of each of the taxi getting on/off places 30 by use of weather information according to a weather condition. Then, the generation unit 204 generates the car allocation information 260, by multiplying the coefficient set for an allocation ratio of car allocation to each of the taxi getting on/off places 30. The generation unit 204 stores the generated car allocation information 260 in the storage apparatus 220.

The generated car allocation information 260 can be displayed on a display of a terminal of a taxi company, similarly to the first example embodiment.

As described above, in the car allocation system 1 according to the present example embodiment, the information processing apparatus (server) 200 includes the weather information acquisition unit 206. The weather information acquisition unit 206 acquires weather information in a region including the passenger waiting region 32. The generation unit 204 further generates the car allocation information 260 of the taxi 20 further by use of weather information.

Thus, according to the present example embodiment, an advantageous effect similar to that according to the example embodiment described above is provided, and, further, the car allocation information 260 can be generated for each of the passenger waiting regions 32 by use of weather information. Thereby, the present example embodiment can optimize car allocation.

### Third Example Embodiment

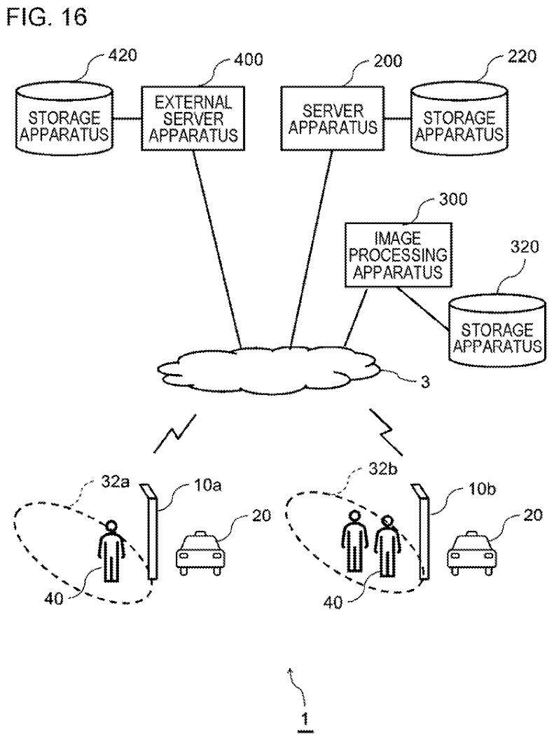

FIG. 16 is a diagram conceptually illustrating a system configuration of a car allocation system 1 according to an example embodiment. The present example embodiment is similar to one of the example embodiments described above except for having a configuration that further uses, for generation of car allocation information, car allocation achievement information owned by a taxi company. Moreover, a configuration according to the present example embodiment may be combined with at least one of configurations according to other example embodiments described later to an extent that produces no conflict.

### <System Outline>

The car allocation system 1 according to the example embodiment is described below by use of FIG. 16. The car allocation system 1 according to the present example embodiment further includes an external server apparatus 400 in addition to a configuration of the car allocation system 1 in FIG. 11. However, the car allocation system 1 may have a configuration further including the external server apparatus 400 in a configuration in FIG. 3. The external server apparatus 400 is connected to a server 200 via a communication network 3. However, in the figure, in order to simplify the figure, the server 200, the image processing apparatus 300, the external server apparatus 400, a sensor apparatus 100 (street light 10) are connected to the same communication network 3. The communication network 3 connecting the server 200 and the external server apparatus 400, the communication network 3 connecting the server 200 and the image processing apparatus 300, and the communication network 3 connecting the server 200 and the sensor apparatus 100 are preferably the different communication networks 3.

The external server apparatus 400 includes a storage apparatus 420 that stores car allocation achievement information of a taxi company. The storage apparatus 420 may be provided inside the external server apparatus 400, or may be provided outside the external server apparatus 400. That is to say, the storage apparatus 420 may be hardware being integral with the external server apparatus 400, or may be hardware being separate from the external server apparatus 400.

Further, in the car allocation system 1, the server 200 may include the storage apparatus 420. In other words, a function of the server 200 (information processing apparatus 200) may be incorporated in the external server apparatus 400.

### Functional Configuration Example

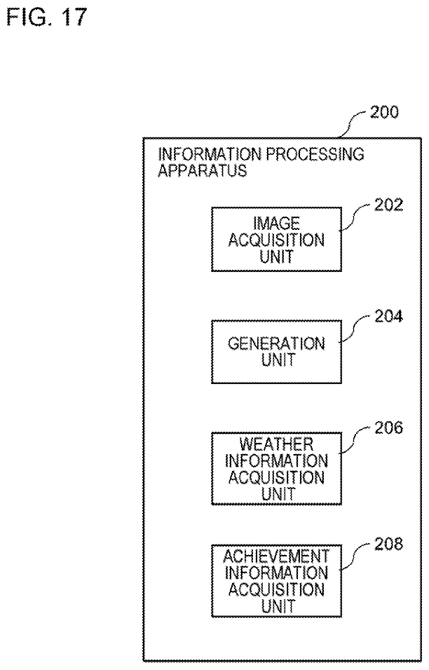

FIG. 17 is a functional block diagram illustrating a functional configuration example of the information processing apparatus 200 according to the example embodiment. The server 200 in FIG. 16 is one example of the information processing apparatus 200.

The information processing apparatus (server) 200 further includes an achievement information acquisition unit 208 in addition to a configuration of the information processing apparatus 200 in FIG. 13. However, a configuration according to the present example embodiment may be combined with at least one of configurations according to the first example embodiment in FIG. 1 and other example embodiments described later to an extent that produces no conflict.

The achievement information acquisition unit 208 acquires achievement information of past congestion status for each of passenger waiting regions 32.

A generation unit 204 generates car allocation information 260 of a taxi 20, further by use of achievement information of past congestion status for each of the passenger waiting regions 32.

The achievement information acquisition unit 208 acquires information owned by a taxi operator. The information owned by a taxi operator includes at least one of achievement information of past congestion status for each of the passenger waiting regions 32, statistical data such as a charge expectation value per person, and information indicating a destination of a customer.

The achievement information acquisition unit 208 acquires, from the external server apparatus 400, achievement information of past congestion status for each of the passenger waiting regions 32, and stores the achievement information in the storage apparatus 220 as achievement information 430.

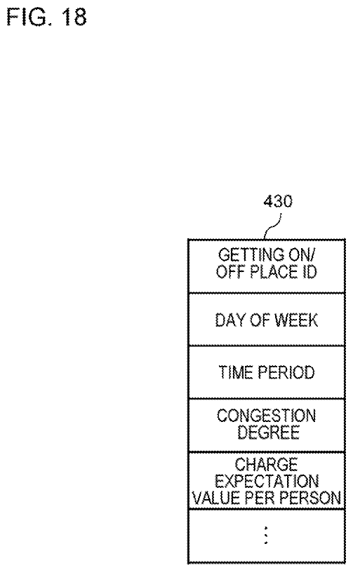

FIG. 18 is a diagram illustrating a data structure example of the achievement information 430. The achievement information 430 includes, for each of the passenger waiting regions 32, a congestion degree indicating congestion status in association with information determining the passenger waiting region 32, for example, a getting on/off place ID. Since a congestion degree fluctuates according to a weekday, a holiday, a public holiday, a day of a week, and a time period, the achievement information 430 includes a congestion degree for each day of a week and each time period. The time period may be a period segmented for each predetermined time interval such as midnight to 6 a.m., 6 a.m. to noon, . . . , or may be a specific period determining a time period having a feature, such as early morning (4 a.m. to 6 a.m.), nighttime (10 p.m. to 3 a.m.), daytime (10 a.m. to 5 p.m.), or a time to go home (5 p.m. to 8 p.m.). Moreover, since a congestion degree fluctuates according to weather as well, the achievement information 430 may further include a congestion degree for each weather.

A congestion degree can be indicated by, for example, at least one of a person count in a taxi queue per time, a person count in which a person count in a taxi queue per time has exceeded a threshold value, and a percentage of a person count in a taxi queue per time to a threshold value. For example, in a case where a threshold value is 10, a congestion degree is 120% when a person count in a taxi queue per time is 12, and a congestion degree is 220% when a person count in a taxi queue per time is 22. A threshold value may be set for each of the passenger waiting regions 32.

Alternatively, a congestion degree may be indicated by at least one of a person count of customers per time, a person count in which a person count of customers per time has exceeded a threshold value, a percentage of a person count of customers per time to a threshold value, the number of the taxies 20 which a customer is caused to get on per time, a number being the number of the taxies 20 which a customer is caused to get on per time and exceeding a threshold value, and a percentage of the number of the taxies 20 which a customer is caused to get on per time to a threshold value.

Alternatively, a congestion degree may be indicated by an average value of a time required for a customer to queue at a taxi on/off place 30 and then get on a taxi. The congestion degrees may be generated by processing an image generated by an image capturing unit of the server 200.

The generation unit 204 generates the car allocation information 260 further by use of pieces of the achievement information 430. For example, when a congestion degree is equal to or more than a threshold value, an allocation ratio of the taxi 20 is increased (e.g., multiplied by a coefficient 1.2, or the like). A coefficient may be set according to a congestion degree. As a congestion degree is great, a coefficient may be set to be great. Alternatively, as a congestion degree is small, a coefficient may be set to be small (e.g., a coefficient smaller than 1).

Alternatively, when statistical data of a charge expectation value per person are used as the achievement information 430, the generation unit 204 may further set an allocation ratio of the taxi 20 according to a proportion of charge expectation values of a plurality of taxi getting on/off places 30. For example, the generation unit 204 may compute an allocation ratio of car allocation to the passenger waiting regions 32 of the plurality of taxi getting on/off places 30 by multiplying each of a proportion of person counts in taxi queues in the passenger waiting regions 32 of the plurality of taxi getting on/off places 30, and a proportion of charge expectation values of the plurality of taxi getting on/off places 30.

Specifically, for example, a case where a proportion of charge expectation values in the passenger waiting regions 32 of the three taxi getting on/off places 30 in the example of FIG. 9 is 1.2:1:0.8 is described. The generation unit 204 multiplies a proportion 5:0:12 of person counts in taxi queues in the passenger waiting regions 32 of the three taxi getting on/off places 30 by the proportion of the charge expectation value described above, in such a way that an allocation ratio of car allocation to the passenger waiting regions 32 of the three taxi getting on/off places 30 is 6:0:9.6.

In still another example embodiment, the generation unit 204 may determine an allocation ratio of car allocation to the passenger waiting regions 32 of the plurality of taxi getting on/off places 30 according to a proportion of charge expectation values of the plurality of taxi getting on/off places 30, without considering a proportion of person counts in taxi queues in the passenger waiting regions 32 of the plurality of taxi getting on/off places 30. In this case, the generation unit 204 determines, to be 1.2:1:0.8, an allocation ratio of car allocation to the passenger waiting regions 32 of the three taxi getting on/off places 30, based on a proportion 1.2:1:0.8 of the charge expectation values in the passenger waiting regions 32 of the three taxi getting on/off places 30 described above. When there are 10 allocatable taxies, the generation unit 204 allots allocatable taxies by 4:3:3.

### Operation Example

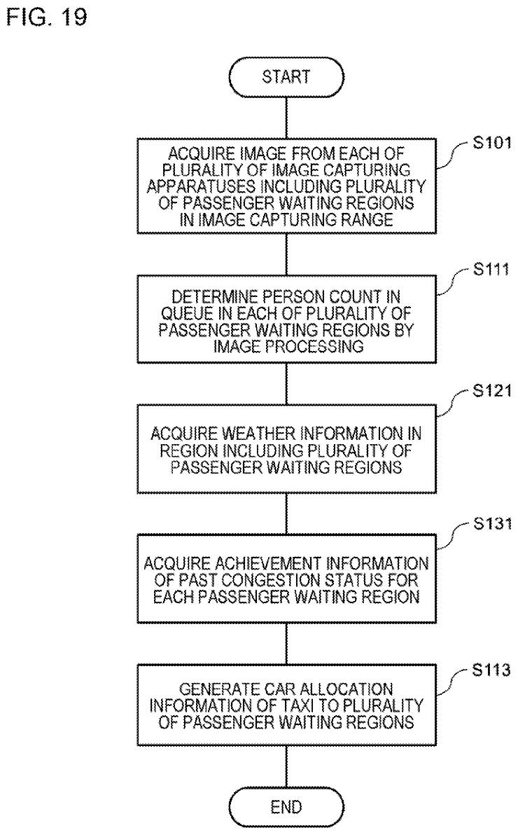

FIG. 19 is a flowchart illustrating an operation example of the server 200 according to the example embodiment. A flow in FIG. 19 includes steps S101, S111, S121, and S113 that are the same as those in a flow in FIG. 15, and further includes step S131.

Steps S101, S121, and S131 are executed regularly, at a predetermined time, or at any time. Moreover, image data acquired in step S101 and weather information acquired in step S121 may be received simultaneously as the sensor transmission data 340. Steps S101, S111, S113, S121, and S131 may be executed asynchronously with each other. For example, steps S111 and S113 are executed at a turn-around time interval of car allocation processing. Step S131 may also be executed at a turn-around time interval of car allocation processing.

Since steps S101 to S121 are the same as those in FIG. 15, description thereof is not included.

First, the achievement information acquisition unit 208 acquires, from the external server apparatus 400, achievement information including past congestion status for each of the passenger waiting regions 32. The achievement information acquisition unit 208 stores the acquired achievement information in the storage apparatus 220 as the achievement information 430. The processing may be preliminarily performed, or may be performed each time. The achievement information acquisition unit 208 reads and acquires, from the achievement information 430, a congestion degree being associated with a current day of a week and time period (step S131).

Then, the generation unit 204 refers to queue person count information 250, and generates the car allocation information 260 of the taxi 20 by use of person counts in taxi queues in the plurality of taxi getting on/off places 30 and further by use of weather information 40 (step S113). The generation unit 204 determines an allocation ratio of car allocation to each of the taxi getting on/off places 30 by use of person counts in taxi queues in the plurality of taxi getting on/off places 30. Further, the generation unit 204 sets a coefficient of each of the taxi getting on/off places 30 by use of weather information according to a weather condition. Further, the generation unit 204 further sets a coefficient of each of the taxi getting on/off places 30 according to a congestion degree of the passenger waiting region 32 of each of the taxi getting on/off places 30 being associated with a day of a week and a time period. The generation unit 204 generates the car allocation information 260, by multiplying the two coefficients by an allocation ratio of car allocation to each of the taxi getting on/off places 30. The generation unit 204 stores the generated car allocation information 260 in the storage apparatus 220.

The generated car allocation information 260 can be displayed on a display of a terminal of a taxi company, similarly to the first example embodiment.

As described above, in the car allocation system 1 according to the present example embodiment, the information processing apparatus (server) 200 includes the achievement information acquisition unit 208. The achievement information acquisition unit 208 acquires achievement information of past congestion status for each of the passenger waiting regions 32. The generation unit 204 generates the car allocation information 260 of the taxi 20 further by use of achievement information of past congestion status for each of the passenger waiting regions 32.

Thus, according to the present example embodiment, an advantageous effect similar to that according to the example embodiment described above is provided, further, the car allocation information 260 can be generated for each of the passenger waiting regions 32, for each day of a week, and for each time period, in consideration of achievement data, and, therefore, car allocation suited to an actual condition of each of the taxi getting on/off places 30 can be performed. Thus, the present example embodiment can optimize car allocation.

### Fourth Example Embodiment

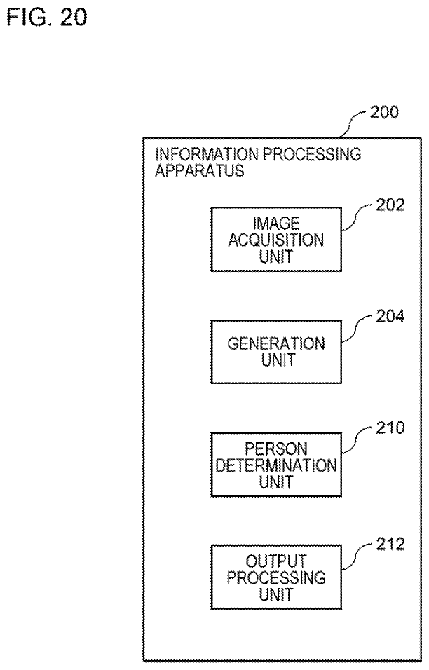

FIG. 20 is a functional block diagram illustrating a logical configuration example of an information processing apparatus 200 according to an example embodiment. The present example embodiment is different from the example embodiment described above in including a configuration that provides contents according to an attribute of a taxi user to the user. The information processing apparatus (server) 200 further includes a person determination unit 210 and an output processing unit 212 in addition to a configuration of the information processing apparatus 200 according to the first example embodiment in FIG. 1. However, a configuration of the information processing apparatus 200 according to the present example embodiment may be combined with at least one of configurations according to other example embodiments other than the first example embodiment in FIG. 1 to an extent that produces no conflict. Moreover, the car allocation system 1 according to the present example embodiment has the same configuration as that according to the third example embodiment in FIG. 16. However, a configuration of the car allocation system 1 according to the present example embodiment may be combined with at least one of configurations according to other example embodiments other than the third example embodiment to an extent that produces no conflict.

### <System Outline>

The car allocation system 1 according to the example embodiment is described below by use of FIG. 16. In the third example embodiment, an external server apparatus 400 includes a storage apparatus 420 that stores car allocation achievement information of a taxi company.

In the present example embodiment, the external server apparatus 400 includes the storage apparatus 420 that stores contents data such as an advertisement. Contents data include, for example, moving image data. However, contents data are not limited to moving image data, may be still image data, may be a website page, or may be audio data, and are not particularly limited.

### Functional Configuration Example

The information processing apparatus 200 according to the example embodiment is described below by use of FIG. 20. The server 200 in FIG. 16 is one example of the information processing apparatus 200.

The person determination unit 210, by processing an image, determines an attribute of a person at a head of a taxi queue in each of passenger waiting regions 32.

The output processing unit 212 causes an output unit to output contents determined by use of the determined attribute of the person.

The person determination unit 210 causes an image processing apparatus 300 to process an image acquired by an image acquisition unit 202, and thereby determines an attribute of a person at a head of a taxi queue. An attribute of a person at a head of a taxi queue includes at least one of, for example, a gender, an age group, and a classification (a company employee, a student, a housewife, an infant, a small child, or the like). Alternatively, as described in other example embodiments described later, the person determination unit 210 may cause the image processing apparatus 300 to process an image, thereby determine a subsequent person (e.g., a person who gets on together with a person at a head, such as a family member, a colleague, or a companion) being associated with a person at a head, and further determine an attribute of the determined subsequent person.

Then, the output processing unit 212 causes the output unit to output contents determined by use of the determined attribute of the person.

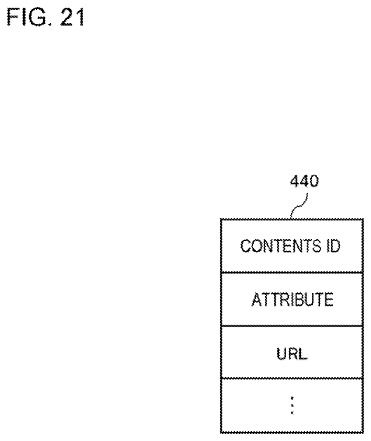

FIG. 21 is a diagram illustrating a data structure example of contents information 440. The contents information 440 includes information (in this example, a uniform resource locator (URL) of a website) indicating contents data for each associated attribute (a gender, an age group, and a classification), in association with identification information (hereinafter, referred to as a contents ID) allocated to contents in order to identify the contents. When contents are moving image data, still image data, and audio data, the contents information 440 may include, as information indicating contents data, information (at least one of a disc name, a folder name, a directory name, and the like, and information indicating a file name (or a path indicating a storage place and a file name)) indicating a storage place of moving image data.

Further, an attribute being associated with contents may be a combination of a plurality of attributes. For example, a combination of attributes may be a gender being male, and an age group being 20s to 30s or the like. Alternatively, a priority order may be set for an attribute being associated with contents. For example, a priority order of an age group of certain contents may be set in order of 20s to 30s, 40s to 50s, 60s to 70s, and equal to or more than an age of 80.

Although an attribute being associated with a contents ID is associated with the contents information 440 in the example of FIG. 21, a contents ID being associated with an attribute may be associated the contents information 440 in another example. The contents information 440 may associate, for each attribute, contents IDs of a plurality of associated contents, together with a priority order.

The output processing unit 212 refers to the contents information 440, and acquires information indicating contents being associated with an attribute of a person. When a plurality of contents being associated with an attribute of a person exist, the output processing unit 212 may select contents being high in a priority order of contents, and acquire information indicating the contents.

Further, contents may be selected according to a day of a week, a time period, weather, or the like.

The output unit is, for example, at least one of a display 112 and a speaker 110 of a street light 10 (sensor apparatus 100) installed in a taxi getting on/off place 30 where the person is present, and a display 58 and a speaker 66 of an on-vehicle apparatus 50 of a taxi 20 which the person gets on.

FIG. 22 is a functional block diagram logically illustrating a configuration example of the on-vehicle apparatus 50. The on-vehicle apparatus 50 includes a control unit 52, a storage unit 54, an operation acceptance unit 56, a display 58, a communication unit 60, a GPS reception unit 62, a microphone 64, and a speaker 66.

The control unit 52 controls the operation acceptance unit 56, the display 58, the communication unit 60, the GPS reception unit 62, the microphone 64, and the speaker 66 of the on-vehicle apparatus 50. The storage unit 54 is a storage apparatus achieved by a RAM, a ROM, and the like. For example, the ROM stores a program module and various kinds of data for the control unit 52 to control each unit of the on-vehicle apparatus 50. The RAM has a work area for the control unit 52 to read and operate a program module when executing the program module, and an area in which data to be transmitted and received are transitorily stored.

The operation acceptance unit 56 accepts an operation of an operation unit such as an operation key, an operation button, a switch, a jog dial, a touch pad, and a touch panel. The display 58 includes a light emitting diode (LED) display, a liquid crystal display, an electroluminescence display, and the like.

The communication unit 60 communicates with another apparatus by wireless communication via an antenna 61. In the present example embodiment, the communication unit 60 communicates with the server 200 on a communication network 3. The GPS reception unit 62 receives positional information via an antenna 63.

When the display 112 or the speaker 110 of the street light 10 serves as an output unit, the output processing unit 212 determines the street light 10 installed in the taxi getting on/off place 30 of the passenger waiting region 32 where a person at a head is present. Then, the output processing unit 212 transmits information indicating contents, for example, a URL of a website to the sensor apparatus 100 of the determined street light 10. Alternatively, the output processing unit 212 acquires contents, based on information indicating contents, for example, a storage place of moving image data, and transmits the acquired contents to the sensor apparatus 100 of the determined street light 10. In the sensor apparatus 100, a communication unit 108 receives information transmitted from the server 200, and outputs contents from the display 112 or the speaker 110, based on the received information.

When the display 58 or the speaker 66 of the on-vehicle apparatus 50 serves as an output unit, the output processing unit 212 determines, by use of positional information of each of the taxies 20, a taxi 20 which a person at a head gets on. The output processing unit 212 receives, from the on-vehicle apparatus 50, positional information acquired by the GPS reception unit 62 of the on-vehicle apparatus 50 of each of the taxies 20. The output processing unit 212 determines, as the taxi 20 which a person at a head gets on, the taxi 20 for which the received positional information indicates a position being closest to information of a getting-on position of the taxi getting on/off place 30. Then, the output processing unit 212 transmits information indicating contents, for example, a URL of a website to the on-vehicle apparatus 50 of the determined taxi 20. Alternatively, the output processing unit 212 acquires contents, based on information indicating contents, for example, a storage place of moving image data, and transmits the acquired contents to the on-vehicle apparatus 50 of the determined taxi 20.

### Operation Example

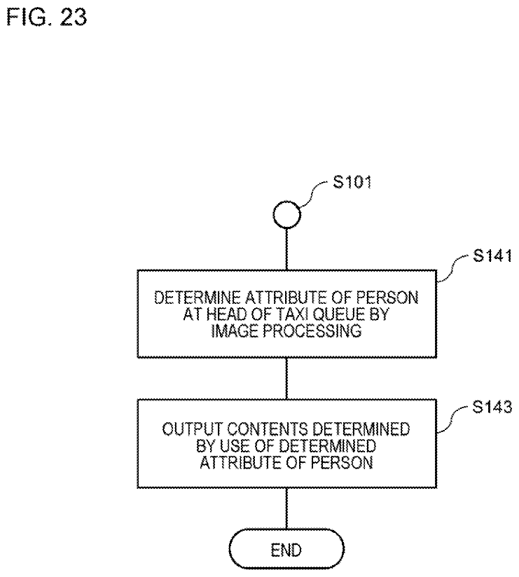

FIG. 23 is a flowchart illustrating an operation example of the server 200 according to the example embodiment. A flow in FIG. 23 is executed after step S101 in a flow in FIG. 2.

First, the person determination unit 210, by processing an image, determines an attribute of a person at a head of a taxi queue (step S141). The person determination unit 210 causes the image processing apparatus 300 to process the image acquired in step S101, thereby determines the person at the head of the taxi queue, and determines an attribute of a person at a head of a taxi queue.

Then, the output processing unit 212 causes the output unit to output contents determined by use of the determined attribute of the person (step S143). The output processing unit 212 determines contents being associated with an attribute of the person at the head determined in step S141. Then, the output processing unit 212 causes the output unit to output determined contents. As one example, the output processing unit 212 causes the display 112 of the street light 10 to display the determined contents. As another example, the output processing unit 212 determines the taxi 20 which a person at a head gets on, and causes the display 58 of the on-vehicle apparatus 50 of the taxi 20 to display the determined contents.

As described above, in the car allocation system 1 according to the present example embodiment, the information processing apparatus (server) 200 includes the person determination unit 210 and the output processing unit 212. The person determination unit 210, by processing an image, determines an attribute of a person at a head of a taxi queue. The output processing unit 212 causes the output unit to output contents determined by use of the determined attribute of the person.

Thus, according to the present example embodiment, an advantageous effect similar to that according to the example embodiment described above is provided, and, further, the car allocation system 1 can effectively provide contents according to an attribute of a person 40 within the passenger waiting region 32.

### Fifth Example Embodiment

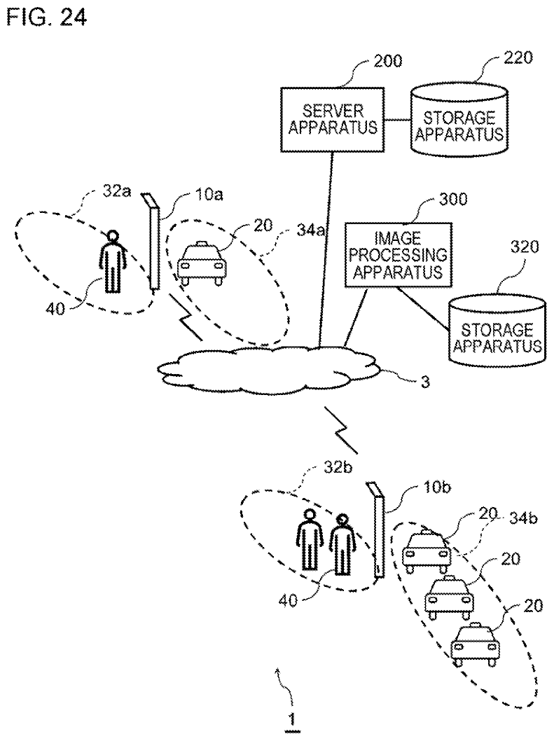

FIG. 24 is a diagram conceptually illustrating a system configuration of a car allocation system 1 according to an example embodiment. The present example embodiment is similar to one of the example embodiments described above, except for having a configuration that generates car allocation information 260 further by use of the number of taxies waiting for a customer.

### <System Outline>

The car allocation system 1 according to the example embodiment is described below by use of FIG. 24. The car allocation system 1 in FIG. 24 has the same configuration as that of the car allocation system 1 in FIG. 11, and is different from the car allocation system 1 in FIG. 11 in acquiring an image including a taxi waiting region 34 from an image capturing unit.

One example of the image capturing unit is an image capturing unit 104 included in a sensor apparatus 100 in FIG. 11. Another example of the image capturing unit is a camera 5 in FIG. 3. Moreover, as still another example, the image capturing unit may be an image capturing unit being different from an image capturing unit 104 included in a sensor apparatus 100 of a street light 10, or may be the camera 5 provided in addition to the camera 5 in FIG. 3.

### Functional Configuration Example

The server 200 according to the present example embodiment has the same configuration as that of the information processing apparatus 200 in FIG. 1, and is therefore described by use of FIG. 1. However, the server 200 according to the present example embodiment may have the configuration of the information processing apparatus 200 according to another example embodiment other than the first example embodiment described above. That is to say, the configuration according to the present example embodiment may be combined with at least one of configurations according to other example embodiments other than the first example embodiment to an extent that produces no conflict.

The image acquisition unit 202 acquires an image including the taxi waiting region 34 where a taxi 20 waiting for a customer waits.

The generation unit 204, by processing the image including the taxi waiting region 34, generates the car allocation information 260 of the taxi 20 for a plurality of passenger waiting regions 32.

The image acquisition unit 202 acquires each image including the taxi waiting region 34 of each of taxi getting on/off places 30. A timing of acquiring the image data may be the same as a timing of acquiring an image including a passenger waiting region 32, or may be different therefrom.

The generation unit 204 causes an image processing apparatus 300 to process an image including the taxi waiting region 34 of each of the taxi getting on/off places 30. The image processing apparatus 300 processes the image, thereby determines the taxi waiting region 34 within the image, and determines a region of the taxi 20 waiting for a customer within the taxi waiting region 34. Then, the image processing apparatus 300 counts regions of the taxies 20, and determines the number of the taxies 20 waiting for a customer within the taxi waiting region 34. The determined number of the taxies 20 is transmitted to the server 200.

The generation unit 204 stores, in a storage apparatus 220, the number of the taxies 20, acquired from the image processing apparatus 300, waiting for a customer in each of the taxi getting on/off places 30, in association with time information and a getting on/off place ID. Note that, a timing of determining the number is preferably every turn-around time of car allocation processing described above.

The number of the taxies 20 waiting for a customer may be determined by use of only an image of a certain time. Alternatively, the number of the taxies 20 waiting for a customer may be an average value, a maximum value, or the like, of the number per time among turn-around times of car allocation processing, determined by use of a plurality of images at a plurality of times among turn-around times of car allocation processing.

Similarly to the example embodiment described above, the generation unit 204 refers to queue person count information 250, and generates car allocation information of the taxi 20 by use of person counts in taxi queues in the plurality of taxi getting on/off places 30. As one example, the generation unit 204 allots the number of the allocatable taxies 20 according to a ratio of person counts in taxi queues in the plurality of taxi getting on/off places 30.

Then, the generation unit 204 further subtracts the number of the taxies 20 waiting for a customer in the taxi getting on/off place 30 from the car allocation number of the allotted taxies 20, and computes the number of the taxies 20 that should be allocated to the taxi getting on/off place 30. The generation unit 204 stores the generated car allocation information 260 of the taxi 20 in the storage apparatus 220. However, a number acquired by subtracting a predetermined number from the number of the taxies 20 waiting for a customer in the taxi getting on/off place 30 may be used for the number to be subtracted from the car allocation number of the allotted taxies 20. Since there is a case where the plurality of taxies 20 waiting for a customer constantly wait due to many users depending on the taxi getting on/off place 30, a value differing for each of the taxi getting on/off places 30 may be set for a predetermined number.

### Operation Example

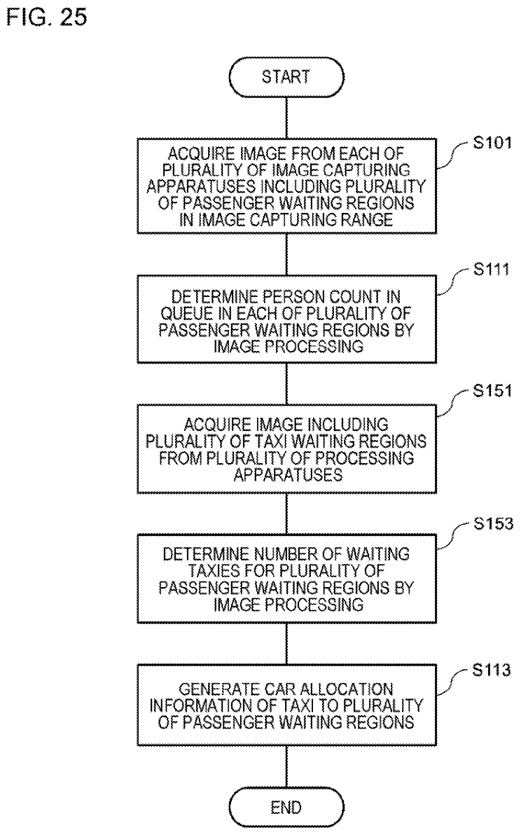

FIG. 25 is a flowchart illustrating an operation example of the server 200 according to the example embodiment. A flow in FIG. 25 includes steps S101, S111, and S113 that are the same as those in a flow in FIG. 10, and further includes steps S151 and S153.

Steps S101 and S151 are executed regularly, at a predetermined time, or at any time. Moreover, image data acquired in step S101 and image data acquired in step S151 may be received simultaneously as the sensor transmission data 340. Steps S101, S111, S113, S151, and S153 may be executed asynchronously with each other. For example, steps S111 and S113 are executed at a turn-around time interval of car allocation processing. Step S153 may also be executed at a turn-around time interval of car allocation processing.

Since steps S101 to S111 are the same as those in FIG. 10, description thereof is not included.

First, the image acquisition unit 202 acquires each image including the taxi waiting region 34 of each of taxi getting on/off places 30 (step S151). Then, the generation unit 204 causes the image processing apparatus 300 to process an image including the taxi waiting region 34 of each of the taxi getting on/off places 30, and thereby determines the number of the taxies 20 waiting for a customer in each of the taxi getting on/off places 30 (step S153).

Then, the generation unit 204 generates the car allocation information 260 of the taxi 20, by use of person counts in taxi queues in the plurality of taxi getting on/off places 30 determined in step S101 and the number of the taxies 20 waiting for a customer in the plurality of taxi getting on/off places 30 determined in step S153 (step S113).

As one example, the generation unit 204 allots the number of the allocatable taxies 20 according to a proportion of person counts in taxi queues in the plurality of taxi getting on/off places 30. Further, the generation unit 204 subtracts the number of the taxies 20 waiting for a customer in the taxi getting on/off place 30 from the car allocation number of the allotted taxies 20, and computes the number of the taxies 20 that should be allocated to the taxi getting on/off place 30. The generation unit 204 generates the car allocation information 260 by use of the computed number. Then, the generation unit 204 stores the generated car allocation information 260 in the storage apparatus 220.

The generated car allocation information 260 can be displayed on a display of a terminal of a taxi company, similarly to the first example embodiment.

As described above, in the car allocation system 1 according to the present example embodiment, the image acquisition unit 202 of the information processing apparatus (server) 200 acquires an image including the taxi waiting region 34 where a taxi 20 waiting for a customer waits. The generation unit 204, by processing the image including the taxi waiting region 34, generates the car allocation information 260 of the taxi 20 for the plurality of passenger waiting regions 32.

Thus, according to the present example embodiment, an advantageous effect similar to that according to the example embodiment described above is provided, further, the car allocation information 260 can be generated further by use of the number of taxies waiting for a customer, and, therefore, car allocation can be optimized.

### Sixth Example Embodiment

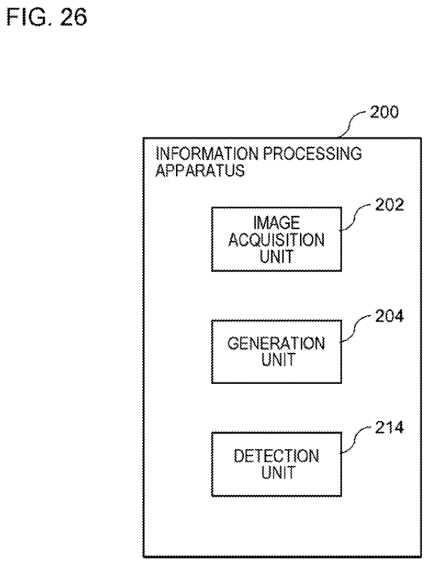

FIG. 26 is a functional block diagram illustrating a logical configuration example of an information processing apparatus 200 according to an example embodiment. The present example embodiment is similar to one of the example embodiments described above in including a configuration that generates, when specific equipment for a person is detected within a taxi queue, car allocation information 260 of a taxi 20 according to the equipment. The information processing apparatus (server) 200 further includes a detection unit 214 in addition to a configuration of the information processing apparatus 200 according to the first example embodiment in FIG. 1. However, a configuration of the information processing apparatus 200 according to the present example embodiment may be combined with at least one of configurations according to other example embodiments other than the first example embodiment in FIG. 1 to an extent that produces no conflict. Moreover, the car allocation system 1 according to the present example embodiment has the same configuration as that according to the second example embodiment in FIG. 11. However, a configuration of the car allocation system 1 according to the present example embodiment may be combined with at least one of configurations according to other example embodiments other than the second example embodiment to an extent that produces no conflict.

### Functional Configuration Example

The detection unit 214 processes an image, and thereby detects specific equipment for a person within a taxi queue of each of passenger waiting regions 32.

When specific equipment for a person is detected, the generation unit 204 generates the car allocation information 260 of the taxi 20 according to the detected equipment for a person.

Specific equipment for a person is, for example, a wheel chair, a cane, a stroller, a suitcase, a ski board, a snowboard, a surf board, baggage equal to or more than a predetermined size, and the like.

The detection unit 214 causes the image processing apparatus 300 to process an image, and thereby detects specific equipment for a person.

When the detection unit 214 detects specific equipment for a person, the generation unit 204 selects the taxi 20 being associated with the detected specific equipment for a person, from among the allocatable taxies 20. Then, the generation unit 204 includes information (e.g., identification information of the taxi 20) of the selected taxi 20 in the car allocation information 260. For example, the generation unit 204 generates identification information of the taxi 20 selected as the taxi 20 that should be allocated to the passenger waiting region 32 in which the detection unit 214 has detected specific equipment for a person in such a way that the identification information is included in the car allocation information 260.

Moreover, when specific equipment for a person is a wheel chair, the generation unit 204 selects the taxi 20 of a vehicle being compatible with a wheel chair, and allocates the taxi 20 to the taxi getting on/off place 30. Information relating to a vehicle of the taxi 20 may be previously acquired and stored in the storage apparatus 220 as vehicle information, or an inquiry may be made at an external server apparatus 400 of a taxi company of the car allocation system 1 according to the third example embodiment in FIG. 18.

When specific equipment for a person is a cane, the generation unit 204 selects the taxi 20 of a vehicle having a shape that is easy to get on and off. When specific equipment for a person is a stroller, the generation unit 204 selects a vehicle in which a size of a trunk is capable of housing the stroller. Alternatively, when specific equipment for a person is a stroller, the generation unit 204 selects a vehicle equipped with a child seat. When specific equipment for a person is one of a suitcase, a snowboard, and baggage equal to or more than a predetermined size, a vehicle in which a size of a trunk is capable of housing the equipment is selected. When specific equipment for a person is a ski board and a surf board, a vehicle equipped with a carrier of each of the ski board and the surf board is selected.

### Operation Example

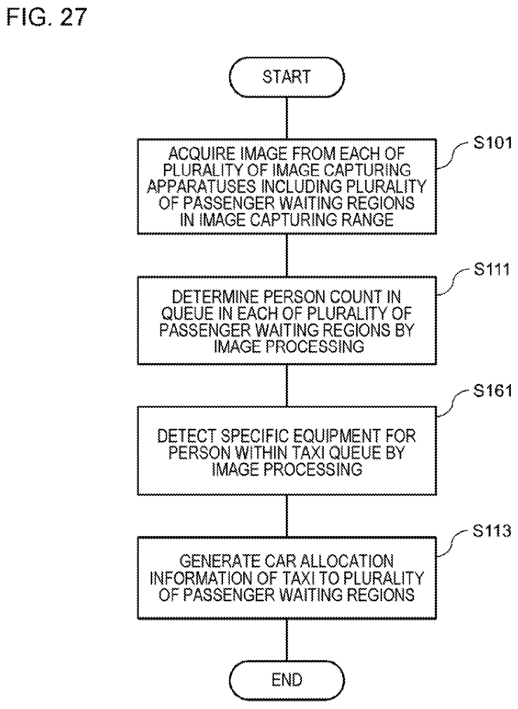

FIG. 27 is a flowchart illustrating an operation example of the server 200 according to the example embodiment. A flow in FIG. 27 includes steps S101, S111, and S113 that are the same as those in a flow in FIG. 10, and further includes step S161.

Step S101 is executed regularly, at a predetermined time, or at any time. Steps S101, S111, S113, S161 may be executed asynchronously with each other. For example, steps S111 and S113 are executed at a turn-around time interval of car allocation processing. Step S161 may also be executed at a turn-around time interval of car allocation processing. Since steps S101 to S111 are the same as those in FIG. 10, description thereof is not included.

First, the detection unit 214 causes the image processing apparatus 300 to process an image, and thereby detects specific equipment for a person within a taxi queue (step S161). Then, the generation unit 204 generates the car allocation information 260 of the taxi 20 by use of person counts in taxi queues in the plurality of taxi getting on/off places 30 determined in step S101, and generates, when specific equipment for a person is detected, the car allocation information 260 including information relating to the taxi 20 selected according to the detected specific equipment for a person (step S113).

As one example, the generation unit 204 allots the number of the allocatable taxies 20 according to a proportion of person counts in taxi queues in the plurality of taxi getting on/off places 30. Further, when specific equipment for a person is detected in step S161, the generation unit 204 selects, from among the allocatable taxies 20, a vehicle being associated with the detected specific equipment for a person.

The generation unit 204 generates, for the passenger waiting region 32 in which the detection unit 214 has detected specific equipment for a person, identification information of the taxi 20 selected as the taxi 20 that should be allocated to the passenger waiting region 32, in such a way that the identification information is included in the car allocation information 260. The generation unit 204 stores the generated car allocation information 260 in the storage apparatus 220.

The generated car allocation information 260 can be displayed on a display of a terminal of a taxi company, similarly to the first example embodiment.

As described above, in the car allocation system 1 according to the present example embodiment, the information processing apparatus (server) 200 further includes the detection unit 214. The detection unit 214, by processing an image, detects specific equipment for a person within a taxi queue. When specific equipment for a person is detected, the generation unit 204 generates the car allocation information 260 of the taxi 20 according to the detected specific equipment for a person.

Thus, according to the present example embodiment, an advantageous effect similar to that according to the example embodiment described above is provided, and, further, when specific equipment for a person is detected within a taxi queue, the car allocation information 260 of the taxi 20 can be generated according to the equipment. For example, when a wheel chair is detected, the taxi 20 being compatible with the wheel chair can be allocated to the passenger waiting region 32. Thus, the present example embodiment can optimize car allocation.

### Seventh Example Embodiment

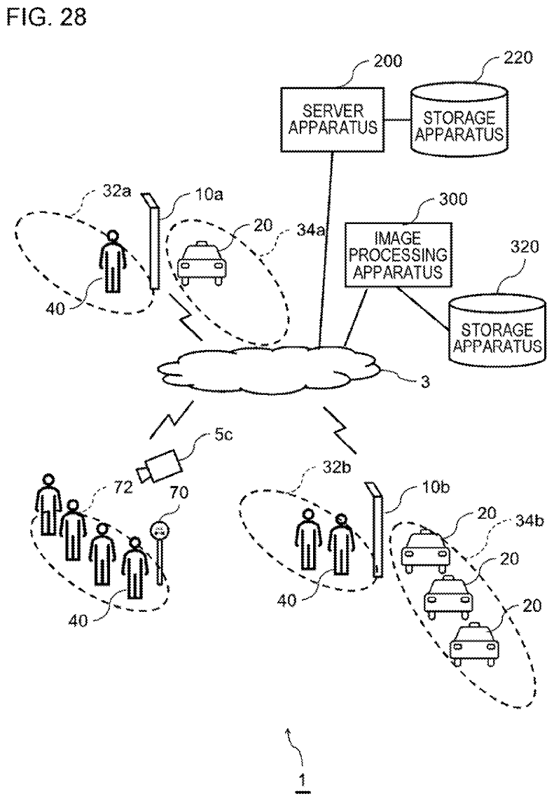

FIG. 28 is a diagram conceptually illustrating a system configuration of a car allocation system 1 according to an example embodiment. The present example embodiment is similar to one of the example embodiments described above in including a configuration that generates car allocation information 260 further by use of a person count in a bus queue of a bus stop 70 around a taxi getting on/off place 30. The information processing apparatus 200 according to the present example embodiment has the same configuration as that according to the first example embodiment in FIG. 1. However, a configuration of the information processing apparatus 200 according to the present example embodiment may be combined with at least one of configurations according to other example embodiments other than the first example embodiment in FIG. 1 to an extent that produces no conflict.

### <System Outline>

The car allocation system 1 according to the example embodiment is described below by use of FIG. 28. The car allocation system 1 in FIG. 28 has the same configuration as that of the car allocation system 1 according to the fifth example embodiment in FIG. 24, and is different from the car allocation system 1 in FIG. 24 in including a configuration that acquires an image capturing a bus stop region 72 where a person waiting for a bus at the bus stop 70 exists. However, the car allocation system 1 according to the present example embodiment may be combined with at least one of configurations according to other example embodiments other than the fifth example embodiment to an extent that produces no conflict.

A third camera 5c is installed in the bus stop 70. The third camera 5c includes, an image capturing range, the bus stop region 72 where a person 40 waiting for a bus at the bus stop 70 exists. The third camera 5c is, for example, a network camera, and is connected to the information processing apparatus 200 via a communication network 3.

An image generated by the third camera 5c is transmitted to the information processing apparatus 200 (or an image processing apparatus 300) in association with information (identification information of the third camera 5c, for example, a sensor ID) with which the third camera 5c is identifiable, and information indicating an image capturing date and time. An acquisition method and a storage method of image data of the third camera 5c in the information processing apparatus 200 are similar to those of image data of a camera 5 in FIG. 3 described in the above example embodiment.

### Functional Configuration Example

A functional configuration example of the server 200 according to the example embodiment is described below by use of FIG. 1. As described above, the server 200 is one example of the information processing apparatus 200 in FIG. 1.

An image acquisition unit 202 acquires an image capturing a bus stop region 72 around a passenger waiting region 32.

A generation unit 204, by processing the image, generates the car allocation information 260 of a taxi 20 for the plurality of passenger waiting regions 32.

The image acquisition unit 202 acquires an image from the third camera 5c.

The generation unit 204 causes the image processing apparatus 300 to process the image acquired by the image acquisition unit 202. The image processing apparatus 300 processes the image, thereby determines the bus stop region 72 within the image, and determines a region of the person 40 existing within the bus stop region 72. Then, the image processing apparatus 300 counts at least some of regions (e.g., a head region and the like) of the person 40, and determines a person count within the bus stop region 72. The determined person count is transmitted to the server 200.

The generation unit 204 generates the car allocation information 260 further by use of a person count within the bus stop region 72 acquired from the image processing apparatus 300. For example, when a person count within the bus stop region 72 is great, it can be assumed that the person 40 who switches to utilization of the taxi 20 arises. Thus, when a person count in the bus stop region 72 is beyond a threshold value, a car allocation number of the taxies 20 to the passenger waiting region 32 around the bus stop region 72 is increased. As one example, when an allocation ratio indicated by the car allocation information 260 generated by the generation unit 204 is increased (e.g., multiplied by a coefficient more than 1, or the like). A coefficient may be set according to a person count in the bus stop region 72. As a person count in the bus stop region 72 is great, a coefficient may be made great.

Further, the information processing apparatus 200 may further include a driving schedule acquisition unit (not illustrated) that acquires a driving schedule of a bus owned by a bus company of a bus around the passenger waiting region 32.

The generation unit 204 may generate the car allocation information 260 by use of the driving schedule of the bus stop 70. For example, the generation unit 204 increases, according to a person count in the bus stop region 72 immediately after a bus has departed, an allocation ratio to the passenger waiting region 32 around the bus stop region 72 indicated by the car allocation information 260. Particularly, when a period until an arrival time of a next bus is equal to or more than a threshold value, the generation unit 204 increases an allocation ratio to the passenger waiting region 32 around the bus stop region. That is to say, immediately after a bus has departed, or when a time until an arrival time of a next bus is long (e.g., 20 minutes or the like), it is likely that there is a customer who switches from bus utilization to utilization of the taxi 20, and, therefore, an allocation ratio is increased.

### Operation Example

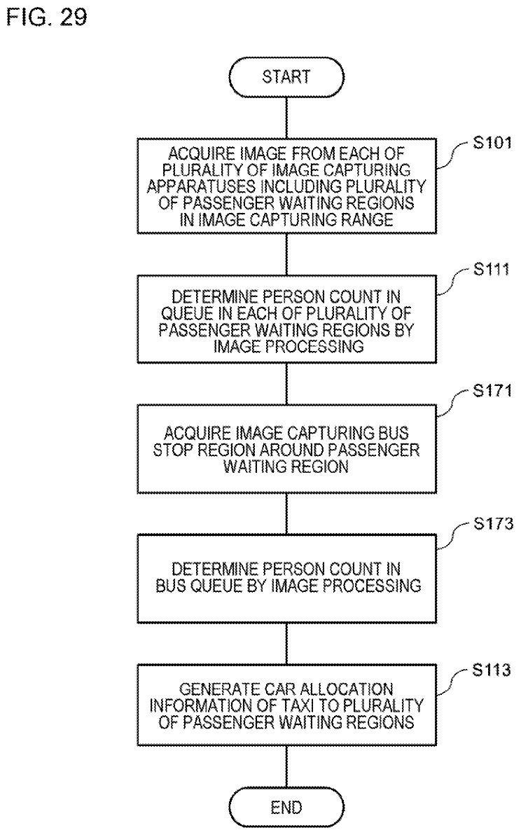

FIG. 29 is a flowchart illustrating an operation example of the server 200 according to the example embodiment. A flow in FIG. 29 includes steps S101, S111, and S113 that are the same as those in a flow in FIG. 10, and further includes steps S171 and S173.

Steps S101 and S171 are executed regularly, at a predetermined time, or at any time. Steps S101, S111, S113, S171, and S173 may be executed asynchronously with each other. For example, steps S111 and S113 are executed at a turn-around time interval of car allocation processing. Steps S171 and S173 are preferably executed at a timing based on a driving schedule of a bus. A timing based on a driving schedule of a bus includes, for example, a timing immediately after departure of a bus, a timing within a period in which a time is equal to or more than a threshold value until arrival of a next bus.

Since steps S101 to S111 are the same as those in FIG. 10, description thereof is not included.

First, the image acquisition unit 202 acquires, from the third camera 5c, an image capturing the bus stop region 72 around the passenger waiting region 32 (step S171). Then, the generation unit 204 causes the image processing apparatus 300 to process the image acquired in step S171, and thereby determines a person count in a bus queue in each of the bus stop regions 72 (step S173). The generation unit 204 generates the car allocation information 260 by use of the person count in the taxi queue determined in step S111, and the person count in the bus queue determined in step S173 (step S113).

As one example, the generation unit 204 totals the person count in the taxi queue determined in step S111, and the person count in the bus queue determined in step S173. That is to say, the generation unit 204 adds the number of customers who switch from bus utilization to taxi utilization, to a person count in a taxi queue. The generation unit 204 allots the number of the allocatable taxies 20 according to a ratio of a total person count in the plurality of taxi getting on/off places 30. The generation unit 204 may multiply a person count in a bus queue determined in step S173 by a predetermined coefficient, and use a result thereof for addition. When it is assumed that some of the persons 40 in a bus queue are likely to switch to utilization of the taxi 20, the coefficient is a value smaller than 1.

The person count in the bus queue determined in step S173 and the person count in the taxi queue determined in step S111 may be added up by use of a value increased and decreased according to an elapsed time since a bus has departed, and a time until a next bus arrives. As an elapsed time since a bus has departed is short, or a time until a next bus arrives is long, customers who switch from bus utilization to taxi utilization are likely to increase. Contrarily, as an elapsed time since a bus has departed is long, or a time until a next bus arrives is short, customers who switch from bus utilization to taxi utilization are likely to decrease. Thus, as an elapsed time since a bus has departed is long, or a time until a next bus arrives is short, the generation unit 204 multiplies a person count in a bus queue used for addition by a smaller coefficient. Then, the generation unit 204 stores the generated car allocation information 260 in a storage apparatus 220.

The generated car allocation information 260 can be displayed on a display of a terminal of a taxi company, similarly to the first example embodiment.

As described above, in the car allocation system 1 according to the present example embodiment, the generation unit 204 of the information processing apparatus (server) 200 generates the car allocation information 260 further by use of a person count in a bus queue of the bus stop 70 (the bus stop region 72) around the taxi getting on/off place 30 (the passenger waiting region 32). In such a case that there are many persons 40 in the bus stop region 72 or a time immediately after a bus has departed or a time until a next bus arrives is long, the generation unit 204 generates the car allocation information 260 by use of a person count acquired by adding up a person count in a taxi queue in the passenger waiting region 32 and a person count in a bus queue in the bus stop region 72.

Thus, according to the present example embodiment, an advantageous effect similar to that according to the example embodiment described above is provided, and, further, the car allocation information 260 of the taxi 20 can be generated assuming a case where the person 40 existing in the bus stop region 72 around the passenger waiting region 32 switches to utilization of the taxi 20. Thereby, even when the persons 40 waiting for a bus in the bus stop 70 around the passenger waiting region 32 switch to utilization of the taxi 20 and move to the passenger waiting region 32, car allocation being compatible with an increase in a person count can be achieved.

While the example embodiments of the present invention have been described above with reference to the drawings, the example embodiments are exemplifications of the present invention, and various configurations other than those described above can also be adopted.

### Another Example Embodiment 1

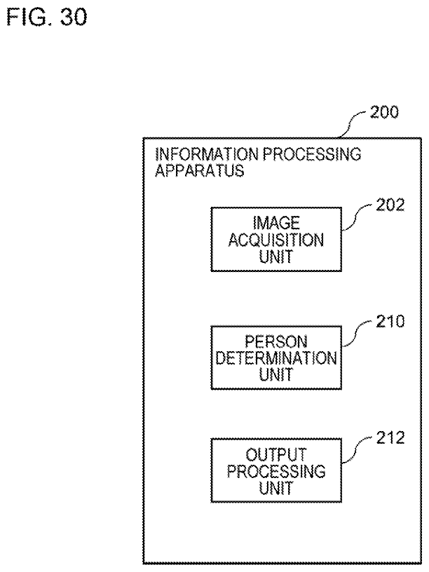

FIG. 30 is a functional block diagram illustrating a logical configuration example of an information processing apparatus 200 according to another example embodiment 1. The information processing apparatus 200 according to the example embodiment includes an image acquisition unit 202, a person determination unit 210, and an output processing unit 212, among components of the information processing apparatus 200 according to the fourth example embodiment in FIG. 20. That is to say, the server 200 in FIG. 30 is a minimum confutation example of a configuration that provides contents according to an attribute of a taxi user to the user.

The configuration may be combined with at least one of configurations according to other example embodiments described above to an extent that produces no conflict.

According to the configuration, the information processing apparatus 200 can effectively provide contents according to an attribute of a person in a taxi queue within a passenger waiting region.

### Another Example Embodiment 2

In another example embodiment 2, a server 200 may have a configuration that determines a group of persons 40 in a taxi queue in a passenger waiting region 32. For example, a generation unit 204, by processing an image of the passenger waiting region 32 acquired by an image acquisition unit 202, determines a group of the persons 40 in a taxi queue in the passenger waiting region 32. The generation unit 204 determines that, for example, a person in the same taxi 20, such as a family member, a colleague, or a companion, is in the same group.

Various conditions can be considered as conditions in which the generation unit 204 determines that the person 40 is in the same group, but are exemplified below. A plurality of the following conditions may be combined.
(1) Detect by image processing that a distance between at least two or more of the persons 40 is equal to or less than a threshold value
(2) Detect, by image processing, movement of mouths of at least two or more of the persons 40, and thereby detect that the persons 40 are conversing with each other
(3) Detect by image processing that bodies of at least two or more of the persons 40 are in contact (holding hands, as one example)
(4) Detect by image processing that an article is transferred between at least two or more of the persons 40

Since the persons 40 determined to be in the same group are likely to be in the same taxi 20, a person count in a taxi queue used when the generation unit 204 generates car allocation information 260 is reduced. That is to say, the generation unit 204 subtracts, from a person count in a taxi queue, an argument acquired by subtracting 1 from a person count of the persons 40 determined to be in the same group, and uses a result thereof for generation of the car allocation information 260.

Alternatively, when a person count of the persons 40 determined to be in the same group is equal to or more than a threshold value (e.g., equal to or more than 5 persons), the generation unit 204 selects a vehicle which the person count is capable of getting on, and generates the car allocation information 260 including information indicating the taxi 20 of the vehicle. Alternatively, when a person count of the persons 40 determined to be in the same group is equal to or more than a threshold value, the generation unit 204 generates the car allocation information 260 in such a way as to allot, to the group, the number of the taxies 20 acquired by splitting the group by a person count being capable of getting on the allocatable taxies 20.

### Another Example Embodiment 3

An information processing apparatus 200 may further include an update unit (not illustrated) that processes an image acquired by an image acquisition unit 202, generates and accumulates information indicating a time of taxi waiting (a time from queuing in a taxi getting on/off place 30 to getting on a taxi 20) for each of passenger waiting regions 32, for each day of a week, for each time period, and updates a congestion degree of achievement information 430 according to the third example embodiment.

### Another Example Embodiment 4

An information processing apparatus 200 may further include a display processing unit (not illustrated) that causes a display 112 of a sensor apparatus 100 to display map information in a vicinity of a passenger waiting region 32. The display processing unit acquires positional information of an allocatable taxi 20, and displays an image indicating a position of the taxi 20 in such a way as to be superposed on the map information in the vicinity of the passenger waiting region 32. Further, the display processing unit updates and displays a position of an image indicating a position of the taxi 20 on a map by use of regularly acquired positional information of the allocatable taxi 20.

Further, the display processing unit may display an image indicating at least one of a scheduled arrival time of the taxi 20 and a time taken until arrival in a superposed way, in association with an image indicating a position of the taxi 20. For example, the display processing unit may associate a balloon image with an image indicating a position of the taxi 20, and include information indicating a scheduled arrival time or the like in the balloon image.

Moreover, although a plurality of processes (pieces of processing) are described in order in a plurality of flowcharts used in the above description, an execution order of the processes executed in each of the example embodiments is not limited to the described order. In each of the example embodiments, an order of the illustrated processes can be changed to an extent that causes no problem in terms of content. Moreover, the example embodiments described above can be combined to an extent that content does not contradict.

While the invention of the present application has been described above with reference to the example embodiments, the invention of the present application is not limited to the example embodiments described above. Various modifications understandable to a person skilled in the art can be made to a configuration and details of the invention of the present application within the scope of the invention of the present application.

Note that, when information relating to a user (e.g., a user of a taxi, a bus, or a movement means) is acquired and utilized in the present invention, the acquisition and utilization are to be performed legally.

Some or all of the above-described example embodiments can also be described as, but are not limited to, the following supplementary notes.

1. An information processing apparatus including:
an image acquisition unit that acquires an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
a generation unit that, by processing the image, generates car allocation information of a taxi for the plurality of passenger waiting regions.
   2. The information processing apparatus according to supplementary note 1, further including
a weather information acquisition unit that acquires weather information of a region including each of the passenger waiting regions, for the plurality of passenger waiting regions, wherein
the generation unit generates the car allocation information of the taxi for the plurality of passenger waiting regions further by use of the weather information of each of the passenger waiting regions.
   3. The information processing apparatus according to supplementary note 2, wherein
the weather information acquisition unit acquires the weather information by generating the weather information by use of data generated by a sensor installed in each of the passenger waiting regions, for the plurality of passenger waiting regions.
   4. The information processing apparatus according to supplementary note 3, wherein
the sensor and the image capturing unit are supported by a same support member.
   5. The information processing apparatus according to any one of supplementary notes 2 to 4, wherein
the weather information acquisition unit acquires prediction information of weather from an external server as the weather information.
   6. The information processing apparatus according to any one of supplementary notes 1 to 5, further including
an achievement information acquisition unit that acquires achievement information of past congestion status for each of the passenger waiting regions, wherein
the generation unit generates the car allocation information of the taxi further by use of the achievement information of the past congestion status for each of the passenger waiting regions.
   7. The information processing apparatus according to supplementary note 6, wherein
the achievement information acquisition unit acquires information owned by a taxi operator as the achievement information.
   8. The information processing apparatus according to any one of supplementary notes 1 to 7, further including:
a person determination unit that, by processing the image, determines an attribute of a person at a head of a taxi queue in each of the passenger waiting regions; and
an output processing unit that causes an output unit to output a content determined by use of the determined attribute of the person.
   9. The information processing apparatus according to any one of supplementary notes 1 to 8, wherein
the image acquisition unit acquires an image including a taxi waiting region where a taxi waiting for a passenger waits, and
the generation unit, by processing the image including the taxi waiting region, generates the car allocation information of the taxi for the plurality of passenger waiting regions.
   10. The information processing apparatus according to any one of supplementary notes 1 to 9, further including
a detection unit that, by processing the image, detects specific equipment for a person within a taxi queue of each of the passenger waiting regions, wherein,
when the specific equipment for the person is detected, the generation unit generates the car allocation information of the taxi according to the detected specific equipment for the person.
   11. The information processing apparatus according to any one of supplementary notes 1 to 10, wherein
the image acquisition unit acquires an image capturing a stop region of a bus around the passenger waiting region, and
the generation unit, by processing the image, generates the car allocation information of the taxi for the plurality of passenger waiting regions.
   12. The information processing apparatus according to any one of supplementary notes 1 to 11, further including
a driving schedule acquisition unit that acquires a driving schedule of the bus owned by a bus company of a bus around the passenger waiting region, wherein
the generation unit generates the car allocation information of the taxi for the plurality of passenger waiting regions further by use of the driving schedule.
   13. A car allocation system including:
a server; and
a plurality of sensor apparatuses provided for each of a plurality of passenger waiting regions where a person waiting for a taxi exists, wherein
each of the plurality of sensor apparatuses includes an image capturing unit having an image capturing range including the plurality of passenger waiting regions, and
the servers includes
an image acquisition unit that acquires an image from the image capturing unit in each of the plurality of passenger waiting regions, and
a generation unit that, by processing the image, generates car allocation information of a taxi for the plurality of passenger waiting regions.
   14. The car allocation system according to supplementary note 13, wherein
the server
further includes a weather information acquisition unit that acquires weather information of a region including each of the passenger waiting regions, for the plurality of passenger waiting regions, wherein
in the server,
the generation unit generates the car allocation information of the taxi for the plurality of passenger waiting regions further by use of the weather information of each of the passenger waiting regions.
   15. The car allocation system according to supplementary note 14, wherein
in the server,
the weather information acquisition unit acquires the weather information by generating the weather information by use of data generated by a sensor installed in each of the passenger waiting regions, for the plurality of passenger waiting regions.
   16. The car allocation system according to supplementary note 15, wherein
the sensor apparatus and the image capturing unit are supported by a same support member.
   17. The car allocation system according to any one of supplementary notes 14 to 16, wherein
in the server,
the weather information acquisition unit acquires prediction information of weather from an external server as the weather information.
   18. The car allocation system according to any one of supplementary notes 13 to 17, wherein
the server further includes
an achievement information acquisition unit that acquires achievement information of past congestion status for each of the passenger waiting regions, and
in the server,
the generation unit generates the car allocation information of the taxi further by use of the achievement information of the past congestion status for each of the passenger waiting regions.
   19. The car allocation system according to supplementary note 18, wherein
in the server,
the achievement information acquisition unit acquires information owned by a taxi operator as the achievement information.
   20. The car allocation system according to any one of supplementary notes 13 to 19, wherein
the server further includes
a person determination unit that, by processing the image, determines an attribute of a person at a head of a taxi queue in each of the passenger waiting regions, and
an output processing unit that causes an output unit to output a content determined by use of the determined attribute of the person.
   21. The car allocation system according to any one of supplementary notes 13 to 20, wherein
in the server,
the image acquisition unit acquires an image including a taxi waiting region where a taxi waiting for a passenger waits, and
the generation unit, by processing the image including the taxi waiting region, generates the car allocation information of the taxi for the plurality of passenger waiting regions.
   22. The car allocation system according to any one of supplementary notes 13 to 21, wherein
the server
further includes a detection unit that, by processing the image, detects specific equipment for a person within a taxi queue of each of the passenger waiting regions, and
in the server,
when the specific equipment for the person is detected, the generation unit generates the car allocation information of the taxi according to the detected specific equipment for the person.
   23. The car allocation system according to any one of supplementary notes 13 to 22, wherein
in the server,
the image acquisition unit acquires an image capturing a stop region of a bus around the passenger waiting region, and
the generation unit, by processing the image, generates the car allocation information of the taxi for the plurality of passenger waiting regions.
   24. The car allocation system according to any one of supplementary notes 13 to 23, wherein
the server
further includes a driving schedule acquisition unit that acquires a driving schedule of the bus owned by a bus company of a bus around the passenger waiting region, and
in the server,
the generation unit generates the car allocation information of the taxi for the plurality of passenger waiting regions further by use of the driving schedule.
   25. An information processing method including,
by one or more computers:
acquiring an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
by processing the image, generating car allocation information of a taxi for the plurality of passenger waiting regions.
   26. The information processing method according to supplementary note 25, further including
by one or more computers,
further acquiring weather information of a region including each of the passenger waiting regions, for the plurality of passenger waiting regions, and
generating the car allocation information of the taxi for the plurality of passenger waiting regions further by use of the weather information of each of the passenger waiting regions.
   27. The information processing method according to supplementary note 26, further including,
by the one or more computers,
acquiring the weather information by generating the weather information by use of data generated by a sensor installed in each of the passenger waiting regions, for the plurality of passenger waiting regions.
   28. The information processing method according to supplementary note 27, wherein
the sensor and the image capturing unit are supported by a same support member.
   29 The information processing method according to any one of supplementary notes 26 to 28, further including,
by the one or more computers,
acquiring prediction information of weather from an external server as the weather information.
   30. The information processing method according to any one of supplementary notes 25 to 29, further including:
by the one or more computers,
further acquiring achievement information of past congestion status for each of the passenger waiting regions; and
generating the car allocation information of the taxi further by use of the achievement information of the past congestion status for each of the passenger waiting regions.
   31. The information processing method according to supplementary note 30, further including,
by the one or more computers,
acquiring information owned by a taxi operator as the achievement information.
   32 The information processing method according to any one of supplementary notes 25 to 30, further including:
by the one or more computers,
by processing the image, determining an attribute of a person at a head of a taxi queue in each of the passenger waiting regions; and
causing an output unit to output a content determined by use of the determined attribute of the person.
   33. The information processing method according to any one of supplementary notes 25 to 32, further including:
by the one or more computers,
acquiring an image including a taxi waiting region where a taxi waiting for a passenger waits; and
by processing the image including the taxi waiting region, generating the car allocation information of the taxi for the plurality of passenger waiting regions.
   34 The information processing method according to any one of supplementary notes 25 to 33, further including:
by the one or more computers,
by processing the image, detecting specific equipment for a person within a taxi queue of each of the passenger waiting regions;
when the specific equipment for the person is detected, generating the car allocation information of the taxi according to the detected specific equipment for the person.
   35. The information processing method according to any one of supplementary notes 25 to 34, further including:
by the one or more computers,
acquiring an image capturing a stop region of a bus around the passenger waiting region; and
by processing the image, generating the car allocation information of the taxi for the plurality of passenger waiting regions.
   36. The information processing method according to any one of supplementary notes 25 to 35, further including:
by the one or more computers,
further acquiring a driving schedule of the bus owned by a bus company of a bus around the passenger waiting region; and
generating the car allocation information of the taxi for the plurality of passenger waiting regions further by use of the driving schedule.
   37. A program that causes a computer to execute:
an image acquisition processing of acquiring an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
a generation processing of generating, by processing the image, car allocation information of a taxi for the plurality of passenger waiting regions.
   38. The program according to supplementary note 37,
further causing the computer to execute:
a weather information acquisition processing of acquiring weather information of a region including each of the passenger waiting regions, for the plurality of passenger waiting regions; and
in the generation processing, generating the car allocation information of the taxi for the plurality of passenger waiting regions further by use of the weather information of each of the passenger waiting regions.
   39. The program according to supplementary note 38, further causing the computer to execute
in the weather information acquisition processing, acquiring the weather information by generating the weather information by use of data generated by a sensor installed in each of the passenger waiting regions, for the plurality of passenger waiting regions.
   40. The program according to supplementary note 39, wherein
the sensor and the image capturing unit are supported by a same support member.
   41. The program according to any one of supplementary notes 38 to 40, further causing the computer to execute
in the weather information acquisition processing, acquiring prediction information of weather from an external server as the weather information.
   42. The program according to any one of supplementary notes 37 to 41,
further causing the computer to execute:
an achievement information acquisition processing of acquiring achievement information of past congestion status for each of the passenger waiting regions; and
in the generation processing, generating the car allocation information of the taxi further by use of the achievement information of the past congestion status for each of the passenger waiting regions.
   43. The program according to supplementary note 42, further causing the computer to execute
in the achievement information acquisition processing, acquiring information owned by a taxi operator as the achievement information.
   44. The program according to any one of supplementary notes 37 to 43, further causing the computer to execute:
a person determination processing of determining, by processing the image, an attribute of a person at a head of a taxi queue in each of the passenger waiting regions; and
an output processing of causing an output unit to output a content determined by use of the determined attribute of the person.
   45. The program according to any one of supplementary notes 37 to 44, further causing the computer to execute:
in the image acquisition processing, acquiring an image including a taxi waiting region where a taxi waiting for a passenger waits; and
in the generation processing, generating, by processing the image including the taxi waiting region, the car allocation information of the taxi for the plurality of passenger waiting regions.
   46. The program according to any one of supplementary notes 37 to 45,
further causing the computer to execute;
a detection processing of detecting, by processing the image, specific equipment for a person within a taxi queue of each of the passenger waiting regions; and
when the specific equipment for the person is detected, in the generation processing, generating the car allocation information of the taxi according to the detected specific equipment for the person.
   47. The program according to any one of supplementary notes 37 to 46, further causing the computer to execute:
in the image acquisition processing, acquiring an image capturing a stop region of a bus around the passenger waiting region; and
in the generation processing, generating, by processing the image, the car allocation information of the taxi for the plurality of passenger waiting regions.
   48. The program according to any one of supplementary notes 37 to 47,
further causing the computer to execute:
a driving schedule acquisition processing of acquiring a driving schedule of the bus owned by a bus company of a bus around the passenger waiting region; and
in the generation processing, generating the car allocation information of the taxi for the plurality of passenger waiting regions further by use of the driving schedule.
   49. A computer-readable storage medium storing a program causing a computer to execute:
an image acquisition processing of acquiring an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
a generation processing of generating, by processing the image, car allocation information of a taxi for the plurality of passenger waiting regions.
   50. The computer-readable storage medium storing the program according to supplementary note 49,
further causing the computer to execute;
a weather information acquisition processing of acquiring weather information of a region including each of the passenger waiting regions, regarding the plurality of passenger waiting regions; and
in the generation processing, generating the car allocation information of the taxi for the plurality of passenger waiting regions further by use of the weather information of each of the passenger waiting regions.
   51. The computer-readable storage medium storing the program according to supplementary note 50, further causing the computer to execute
in the weather information acquisition processing, acquiring the weather information by generating the weather information by use of data generated by a sensor installed in each of the passenger waiting regions, for the plurality of passenger waiting regions.
   52. The computer-readable storage medium storing the program according to supplementary note 51, wherein
the sensor and the image capturing unit are supported by a same support member.
   53. The computer-readable storage medium storing the program according to any one of supplementary notes 50 to 52, further causing the computer to execute
in the weather information acquisition processing, acquiring prediction information of weather from an external server as the weather information.
   54. The computer-readable storage medium storing the program according to any one of supplementary notes 49 to 53,
further causing the computer to execute:
an achievement information acquisition processing of acquiring achievement information of past congestion status for each of the passenger waiting regions; and
in the generation processing, generating the car allocation information of the taxi further by use of the achievement information of the past congestion status for each of the passenger waiting regions.
   55. The computer-readable storage medium storing the program according to supplementary note 54, further causing the computer to execute
in the achievement information acquisition processing, acquiring information owned by a taxi operator as the achievement information.
   56. The computer-readable storage medium storing the program according to any one of supplementary notes 49 to 55, further causing the computer to execute:
a person determination processing of determining, by processing the image, an attribute of a person at a head of a taxi queue in each of the passenger waiting regions; and
an output processing of causing an output unit to output a content determined by use of the determined attribute of the person.
   57. The computer-readable storage medium storing the program according to any one of supplementary notes 49 to 56, further causing the computer to execute:
in the image acquisition processing, acquiring an image including a taxi waiting region where a taxi waiting for a passenger waits; and
in the generation processing, generating, by processing the image including the taxi waiting region, the car allocation information of the taxi for the plurality of passenger waiting regions.
   58. The computer-readable storage medium storing the program according to any one of supplementary notes 49 to 57,
further causing the computer to execute:
a detection processing of detecting, by processing the image, specific equipment for a person within a taxi queue of each of the passenger waiting regions; and
when the specific equipment for the person is detected, in the generation processing, generating the car allocation information of the taxi according to the detected specific equipment for the person.
   59. The computer-readable storage medium storing the program according to any one of supplementary notes 49 to 58, further causing the computer to execute:
in the image acquisition processing, acquiring an image capturing a stop region of a bus around the passenger waiting region; and
in the generation processing, generating, by processing the image, car the allocation information of the taxi for the plurality of passenger waiting regions.
   60. The computer-readable storage medium storing the program according to any one of supplementary notes 49 to 59,
further causing the computer to execute:
a driving schedule acquisition processing of acquiring a driving schedule of the bus owned by a bus company of a bus around the passenger waiting region; and
in the generation processing, generating the car allocation information of the taxi for the plurality of passenger waiting regions further by use of the driving schedule.

1. An information processing apparatus comprising:
at least one memory configured to store instructions; and
at least one processor configured to execute the instructions to:
acquire an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions, respectively; and
by processing the image, generate car allocation information of a taxi for the plurality of passenger waiting regions.

2. The information processing apparatus according to claim 1, wherein the at least one processor is configured to further execute the instructions to:
acquire weather information of a region including each of the passenger waiting regions, for the plurality of passenger waiting regions; and
generate the car allocation information of the taxi for the plurality of passenger waiting regions further by use of the weather information of each of the passenger waiting regions.

3. The information processing apparatus according to claim 2, wherein the at least one processor is configured to further execute the instructions to acquire the weather information by generating the weather information by use of data generated by a sensor installed in each of the passenger waiting regions, for the plurality of passenger waiting regions.

4. The information processing apparatus according to claim 3, wherein
the sensor and the image capturing unit are supported by a same support member.

5. The information processing apparatus according to claim 2, wherein the at least one processor is configured to further execute the instructions to
acquire prediction information of weather from an external server as the weather information.

6. The information processing apparatus according to claim 1, wherein the at least one processor is configured to further execute the instructions to:
acquire achievement information of past congestion status for each of the passenger waiting regions; and
generate the car allocation information of the taxi further by use of the achievement information of the past congestion status for each of the passenger waiting regions.

7. The information processing apparatus according to claim 6, wherein the at least one processor is configured to further execute the instructions to acquire information owned by a taxi operator as the achievement information.

8. The information processing apparatus according to claim 1, wherein the at least one processor is configured to further execute the instructions to:
by processing the image, determine an attribute of a person at a head of a taxi queue in each of the passenger waiting regions; and
cause an output unit to output a content determined by use of the determined attribute of the person.

9. The information processing apparatus according to claim 1, wherein the at least one processor is configured to further execute the instructions to:
acquire an image including a taxi waiting region where a taxi waiting for a passenger waits; and
by processing the image including the taxi waiting region, generate the car allocation information of the taxi for the plurality of passenger waiting regions.

10. The information processing apparatus according to claim 1, wherein the at least one processor is configured to further execute the instructions to:
by processing the image, detect specific equipment for a person within a taxi queue of each of the passenger waiting regions; and
when the specific equipment for the person is detected, generate the car allocation information of the taxi according to the detected specific equipment for the person.

11. The information processing apparatus according to claim 1, wherein the at least one processor is configured to further execute the instructions to:
acquire an image capturing a stop region of a bus around the passenger waiting region; and
by processing the image, generate the car allocation information of the taxi for the plurality of passenger waiting regions.

12. The information processing apparatus according to claim 1, wherein the at least one processor is configured to further execute the instructions to:
acquire a driving schedule of the bus owned by a bus company of a bus around the passenger waiting region; and
generate the car allocation information of the taxi for the plurality of passenger waiting regions further by use of the driving schedule.

13. An information processing method comprising,
by one or more computers:
acquiring an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
by processing the image, generating car allocation information of a taxi for the plurality of passenger waiting regions.

14. A non-transitory computer-readable storage medium storing a program that causes a computer to execute:
a processing of acquiring an image from each of a plurality of image capturing units being provided for each of a plurality of passenger waiting regions where a person waiting for a taxi exists, the plurality of image capturing units each having an image capturing range, and the image capturing ranges of the plurality of image capturing units including the plurality of passenger waiting regions in an image capturing range, respectively; and
a processing of generating, by processing the image, car allocation information of a taxi for the plurality of passenger waiting regions.
